(19) United States
(12) Patent Application Publication
(10) Pub. No.: US 2015/0018245 A1
(43) Pub. Date: Jan. 15, 2015

(54) LIPID ARRAYS ON FABRICATED DEVICES AND USES THEREOF

(71) Applicant: ARRAYOMICS, INC., San Diego, CA (US)

(72) Inventors: Edward T. Castellana, San Diego, CA (US); Bao Nguyen, San Diego, CA (US); David Rothwarf, San Diego, CA (US)

(73) Assignee: ARRAYOMICS, INC., San Diego, CA (US)

(21) Appl. No.: 14/387,198

(22) PCT Filed: Mar. 21, 2013
(86) PCT No.: PCT/US2013/033348

§ 371 Date: Sep. 22, 2014

Related U.S. Application Data
(60) Provisional application No. 61/613,811, filed on Mar. 21, 2012.

(51) Int. Cl. G01N 21/64; B01J 19/00

(52) U.S. Cl. CPC G01N 21/6458; B01J 19/0046; G01N 21/6428; G01N 2201/067
USPC 506/12; 506/15; 506/39

(57) ABSTRACT

Systems and methods for arranging microdevices on an array substrate are described. Each microdevice contains a lipid bilayer region and a patterned magnetic material that has a predetermined preferential axis of magnetization. The microdevices are located at specific locations on the arraying substrates and a magnetic field is used to orient the microdevices to facilitate the study of lipids and lipid-associated moieties. The bilayer region can also contain a fluorescent reagent, which can be monitored during exposure to an excitation source. The fluorescent reagent can also be photobleached and monitored for fluorescence recovery.

This application is a claims the benefit of priority to U.S. provisional application Ser. No. 61/613,811, filed on Mar. 21, 2012. This and all other referenced extrinsic materials are incorporated herein by reference in their entirety. Where a definition or use of a term in a, reference that is incorporated by reference is inconsistent or contrary to the definition of that term provided herein, the definition of that term provided herein is deemed to be controlling.

### FIELD OF THE INVENTION

The present invention relates generally to biological and biomimetic membranes on microfabricated devices. In particular, the invention relates to arrays of microdevices containing mutually distinct lipid moieties or composition of lipid moieties and their uses.

### BACKGROUND

The following background description includes information that may be useful in understanding the present invention. It is not an admission that any of the information provided herein is prior art or relevant to the presently claimed invention, or that any publication specifically or implicitly referenced is prior art. References and publications are cited in shorthand form throughout the Background section. A full citation of the references can be found in the “References” section at the end of the specification.

All publications herein are incorporated by reference to the same extent as if each individual publication or patent application were specifically and individually indicated to be incorporated by reference. Where a definition or use of a term in an incorporated, reference is inconsistent or contrary to the definition of that term provided herein, the definition of that term provided herein applies and the definition of that term in the reference does not apply.

A lipid bilayer allows cellular processes to be studied in on environment where membrane fluidity is conserved (Sackmann 1996). The basic properties of lipid bilayers allow them to be easily produced and coupled to solid supports (e.g., silicon dioxide or polymers) while preserving the natural fluidity of the membrane (Castellana et al. 2006, Groves 2002, Sackmann 1996). Lipid bilayers on solid supports are called Supported Lipid Bilayers (SLBs). The use of a solid support helps to stabilize the lipid bilayer and allows it to be probed by a variety of surface specific analytical techniques. While there are several examples in the literature where SLB arrays are employed for investigations of cell membrane processes, the arrays tend to be limited in size and/or complexity (Castellana et al. 2007, Majd et al. 2008, Yamazaki et al. 2005), SUB systems are easily reproduced on small scales, but are notably difficult and costly to scale up to commercial levels using traditional planar microarray technology (Castellana 2006, Groves 2002, Majd 2008). A major challenge in fabricating arrays of SLBs is maintaining constant hydration of the lipid bilayers. The process of drying and rehydration, commonly employed during the production of planar microarrays, can destabilize the lipid bilayer leading to its delamination from the surface and denaturation of any membrane protein present. A handful of systems have been devised to overcome the issue of dehydration. However, the methods they employ often result in excessive change to membrane fluidity or significantly alter the chemical environment at the immediate surface of SLB, thereby affecting their overall utility of the platform. The hydration requirement further poses an obstacle to producing high-density planar arrays since individual elements must be addressed into separated compartments in order to prevent (Cremer et al, 1999).

A wide variety of methods of forming SLBs and biomimetic membranes have been developed and used on solid surfaces (Tanaka & Sackmann, 2005; Castellana & Cremer, 2006; Kiessing et al. 2008; U.S. Pat. No. 6,541,071; U.S. Pat. No. 6,756,078; U.S. Pat. No. 7,208,089; U.S. application Ser. No. 12/437,893; U.S. application Ser. No. 12/049,649). Many of these approaches depend on the use of spacers or “polymer cushions” between the solid support and the bilayer. Without a polymer cushion, membrane proteins with large peripheral domains will denature on the underlying support and not retain proper function (Wong et al, 1999). Examples of polymer cushions include polyethylenimine (PEI)(Wong et al. 1999), polyelectrolyte cushions of polydiallyldimethylammonium chloride (PDDA) and polystyrene sulfonate sodium salt (PSS) (Ma et al, 2003, Onda et al, 1997, Zhang et al, 2000), and polyethylene glycol (Albertorio et al, 2005, Wagner et al. 2000). Often it is necessary and/or beneficial to tether the SUB to the underlying polymer cushion, examples of such tethers include cholesterol (Deng et al. 2008) and chemically modified lipids (Albertorio 2005, Lee et al. 2009, Naumann et al. 2002, Wagner 2000).

SLBs on microparticles has been known in the art for over 20 years (Wilson et al. 1988; Troutier & Ladavière, 2007) and microparticle/microdevice patents have included proposed uses of lipid membranes on such devices including their use on encoded microparticles (U.S. Pat. Nos. 7,718,419 and 7,332,349). In recent years SLBs formed on nanoparticles have been constructed (Nordlund et al 2009; Claesson et al, 2011; Nath et al., 2007). Despite these examples, the pursuit of multiplex SLB assay platforms has largely been focused on the use of large planar substrates. SLB and membrane spatial microarrays have been proposed and produced by many researchers (Cremer & Yang, 1999; Kam & Boxer, 2000; Castellana & Cremer 2007; Smith et al., 2008; Kaufmann et al, 2011; U.S. Pat. No. 6,228,326; U.S. Pat. No. 6,503,452; U.S. Pat. No. 6,977,155; U.S. Pat. No. 7,407,768; U.S. Pat. No. 7,678,539; U.S. Pat. No. 8,017,346). Processes to produce these microarrays mimic the production of DNA microarrays typically using spotting, stamping, or microfluidics to create the microarrays. However, SLBs are not as amenable to spotting and printing techniques as more microarray friendly reagents such as DNA.

A key method for evaluating the existence and fluidity of SLBs on surfaces is to monitor “Fluorescence Recovery After Photobleaching” (FRAP) (Kiessling et al. 2008; Rayan et al, 2010). FRAP is a method of measuring diffusion in cell, lipid, and biological membranes. The procedure has been in use since the 1970s (Edidin et al. 1976; Axelrod, D. et al. 1976). While widely used in cell based assays FRAP experiments also provide a means of characterizing artificial membranes and SLBs. FRAP experiments are typically performed in a one-a-time manner with a small section of membrane exposed to an intense focused light source.

SLBs have been used electrophoretic separations including being used for the analysis and purification of membrane bound proteins (Phillips et al. 2008; Liu et al. 2011; Monson et al. 2011).

Lipid detergent mixtures, including lipidic mesophases and sponge phases, have been used as a crystallization matrix to facilitate the crystallization and determination of crystal structures of membrane bound proteins (Caffrey et al. 2011; Li & Ismagilov, 2010). FRAP is one of the essential methods used to aid in the development of suitable crystallization conditions (Xu et al. 2011). Such approaches have resulted in the determination of crystal structures for G protein-coupled receptors (GPCRs). A key aspect of these approaches is the identification of suitable crystallization conditions using a very small amount of protein.

While as referenced above SLBs can be formed by fusing vesicles and cells or cell fragments to a solid support; vesicles, cells, cellular organelles, and other lipid containing moieties can also be attached solid supports by means that do not require association of the majority of the lipid content in said moiety with the solid surface. Examples such as the widely used methods of adherent cell culture fall into this category. A wide range of surface chemistries have been developed in the cell culture field to promote attachment and growth of cultured cells on a solid support. Such attachment and growth proceed without rupturing of the cell or membrane fusion with the underlying support. Other types of membrane based assays proceed by means of partial fusion of the membrane to the solid support. One notable example of these type of assays are those involving patch clamping, in which a small portion of the cell membrane fuses with the support (e.g. capillary or planar surface) allowing access to the interior of the cell through an opening in the solid support.

### SUMMARY OF THE INVENTION

The present invention provides systems and methods in which lipids or lipid containing moieties are disposed in an array,

In one aspect of preferred embodiments, each lipid containing element in the array consists of an individual microdevice. Microdevices contain features, dimensions, and structural elements that facilitate the study of lipid or lipid-associated moieties. Said microdevices are manipulated, arranged, and displayed in an ordered array by magnetic methods.

In another preferred embodiment, substrate(s) contains a masking pattern that enables FRAP measurements to be carried out in a parallel manner.

The present invention relates to methods and composition for producing and using arrays of membranes on fabricated devices. In one embodiment, microdevices containing a predetermined preferential axis of magnetization and displaying lipid bilayers are disposed in an array having discreet regions. Methods are also contemplated for using masking patterns on the arraying substrate and the microdevices to allow FRAP assays to be performed in a parallel multiplex manner. Preferred methods photobleach by directing light through one face of the substrate and the fluorescence recovery is monitored on the opposite face of the substrate. Also contemplated are microdevice libraries in which microdevices having mutually distinct codes contain a region with a mutually distinct lipid composition, protein moiety, attachment chemistry, or polymer cushion. Exemplary uses for such lipid-containing libraries include drug screening, optimization of protein purification and separation protocols, and optimization of protein crystallization conditions. In these applications, as a consequence of technical limitations such screening and optimizations procedures involving lipids are carried out in low numbers where 100 representations is considered a large library. The current invention substantially increases the practical size of such libraries.

For purposes of summarizing the claimed inventions and their advantages achieved over the prior art, certain objects and advantages of the inventive subject matter have been described herein. Of course, it is to be understood that not necessarily all such objects or advantages can be achieved in accordance with any particular embodiment. Thus, for example, those skilled in the art will recognize that the inventive concepts can be embodied or carried out in a manner that achieves or optimizes one advantage or group of advantages as taught herein without necessarily achieving other objects or advantages as can be taught or suggested herein.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of microdevices containing FRAP Mask, coding pattern, and magnetic elements.

FIGS. 2A-B are schematics of microdevices containing fluorescent enhancement features.

FIGS. 3A-B are schematics of a portion of an arraying chip containing a masking layer.

FIG. 4 is a schematic of a traditional microscope based FRAP configuration using a laser and an inverted total internal reflection fluorescence microscope

FIG. 5 is a schematic of a FRAP experiment on a single microdevice using a conventional microscope approach

FIG. 6 is a schematic of a FRAP configuration using a FRAP Mask.

FIG. 7 is a schematic of FRAP Mask designs, including single and multiple geometric shapes, concentric rings, lines with uniform and non uniform distributions, and crossing lines,

FIGS. 8A-E are schematics of microdevices containing FRAP Masks and additional features including optical codes, magnetic, elements and wells,

FIGS. 9A-L are schematics of microdevices containing FRAP Masks and slots.

FIGS. 10A-D are schematics of a multiplex FRAP on arrayed microdevices where each microdevice contains a FRAP Mask.

FIGS. 11A-D are schematics of a FRAP assay procedure using microdevices.

FIGS. 12A-D are schematics of an ion channel assay procedure using microdevices with arraying chip sensors,

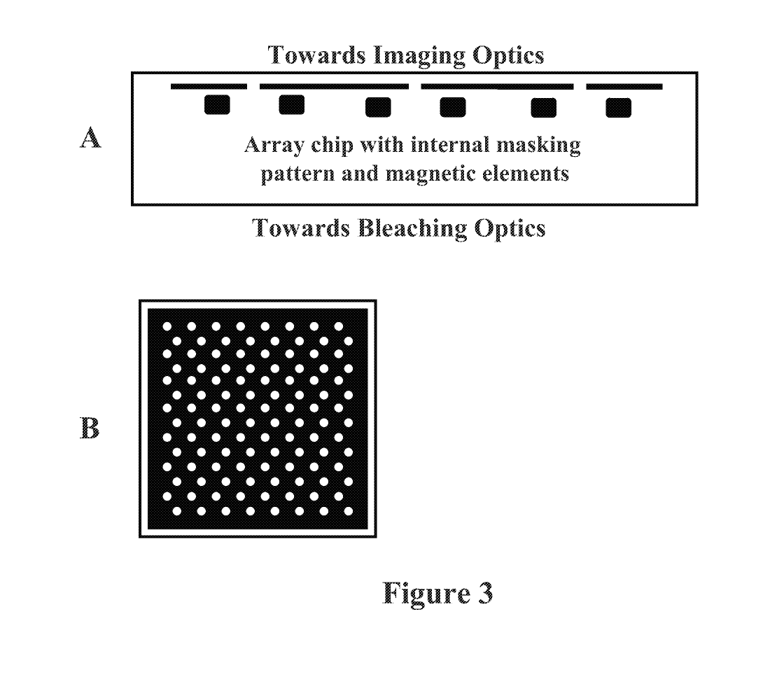

FIGS. 3A-E are schematics of an ion channel assay procedure using microdevices with internal sensors.

FIGS. 14A-D are schematics of an GPCR assay using microdevices with internal sensors as shown in FIG. 13,

FIGS. 15A-E are schematics of an electrophoresis separation assay using microdevices.

### DETAILED DESCRIPTION OF THE DRAWINGS

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, D, even if not explicitly disclosed,

### DEFINITIONS

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference. In instances where a definition is not set forth in this application and conflicting definitions arise amongst definitions incorporated herein by reference; those definitions given in US Patent Application 20080176762 “Microdevice Arrays Formed by Magnetic Assembly” shall prevail.

As used herein, the term “FRAP Mask” means a patterned layer within a substrate, where said patterned layer blocks transmission of light to an extent that allows selective photobleaching of fluorescent moieties (e.g. fluorophores in a lipid bilayer) localized on or within said substrate in the unmasked regions to an extent that can be temporally resolved from the unbleached regions. A FRAP Mask can be opaque at any desired wavelength(s). In some applications it need not be fully opaque at the desired wavelength. For example, reducing transmission of light by 90% while using a multiphoton photobleaching method would result in the photobleaching of the 10% transmission region being significantly less than 1% of the photobleaching in the higher transmission (e.g., 100%) region. It is desirable that the substrate containing a FRAP Mask be substantially transparent at the photobleaching wavelength, “Substantially transparent” need not be fully transparent (100% transmission) but rather corresponds to transmission of sufficient light at the photobleaching wavelength to photobleach the desired target without causing excessive heating. If non-transmitted light is reflected rather than absorbed (thereby not contributing to substrate heating) than “substantially transparent” can correspond to transmission levels lower than 50%. In preferred embodiments absorption at the photobleaching wavelength through the unmasked portion of a substrate containing a FRAP Mask is less than 5%. In further preferred embodiments absorption at the photobleaching wavelength through the unmasked portion of a substrate containing a FRAP Mask is less than 1%. In preferred embodiments transmission of light at the photobleaching wavelength is at least 10 fold greater through the substrate containing a FRAP Mask than through the FRAP Mask. In further preferred embodiments transmission of light at the photobleaching wavelength is at least 100 fold greater through the substrate containing a FRAP Mask than through the FRAP Mask.

As used herein, a “predetermined, preferential axis of magnetization” means a preferential axis of magnetization that can be predetermined through knowledge of the manufacturing process and design of the microdevice. The “predetermined preferential axis of magnetization” of a microdevice is a fundamental aspect of preferred designs. For example, bar-shaped elements of CoTaZr as used in many of the examples presented in this application have a predetermined preferential axis of magnetization that is parallel to the long axis of the magnetic bar. A “predetermined preferential axis of magnetization” is a property of a microdevice that depends on the geometry, composition, and structural configuration of the magnetic elements of the microdevice. Bar-shaped elements of CoTaZr as used in many of the examples presented in this application have a predetermined preferential axis of magnetization that is parallel to the long axis of the bar, by contrast conventional magnetic beads which have a random distribution of magnetic material do not have a predetermined preferential axis of magnetization. The induced magnetization along the predetermined preferential axis of magnetization (in its absolute magnitude) is larger than or at least equal to induced magnetization along any other axis of the microdevice. In general, for the microdevices of the present invention to rotate or orient itself under the interaction of the applied magnetic field and the induced magnetization, the induced magnetization (in its absolute magnitude) along the predetermined preferential axis of magnetization of the microdevice should be at least 20% more than the induced magnetization of the microdevice along at least one other axis. Preferably, the induced magnetization (in its absolute magnitude) along the predetermined preferential axis of magnetization of the microdevices of the present invention should be at least 50%, 70%, or 90% more than the induced magnetization of the microdevice along at least one other axis. Even more preferably, the induced magnetization (in its absolute magnitude) along the predetermined preferential axis of the magnetization of the microdevices of the present invention should be at least two, five times, ten times, twenty times, fifty times or even hundred times more than the induced magnetization of the microdevice along at least one other axis. Similarly for the arraying chip, preferably, the induced magnetization (in its absolute magnitude) along the predetermined preferential axis of magnetization of the arraying chip in the present invention should be at least 50%, 70%, or 90% more than the induced magnetization along at least one other axis. Even more preferably, the induced magnetization (in its absolute magnitude) along the predetermined preferential axis of the magnetization of the arraying chip of the present invention should be at least two, five times, ten times, twenty times, fifty times or even hundred times more than the induced magnetization of the microdevice along at least one other axis. Additionally, at least some of the individual magnetic elements within the microdevice and the arraying chip should have an induced magnetization (in its absolute magnitude) along their predetermined preferential axis of magnetization at least 50%, 70%, or 90% more than the induced magnetization of the element along at least one other axis. Even more preferably, the induced magnetization (in its absolute magnitude) along the predetermined preferential axis of the magnetization of at least some of the individual magnetic elements in the microdevice and arraying chip should be at least two, five times, ten times, twenty times, fifty times or even hundred times more than the induced magnetization of the element along at least one other axis.

Embodiments are directed to devices and methods for forming magnetically assembled arrays of microdevices and uses thereof. For clarity of disclosure, and not by way of limitation, a detailed description is divided into the subsections that follow.

### FIGURES

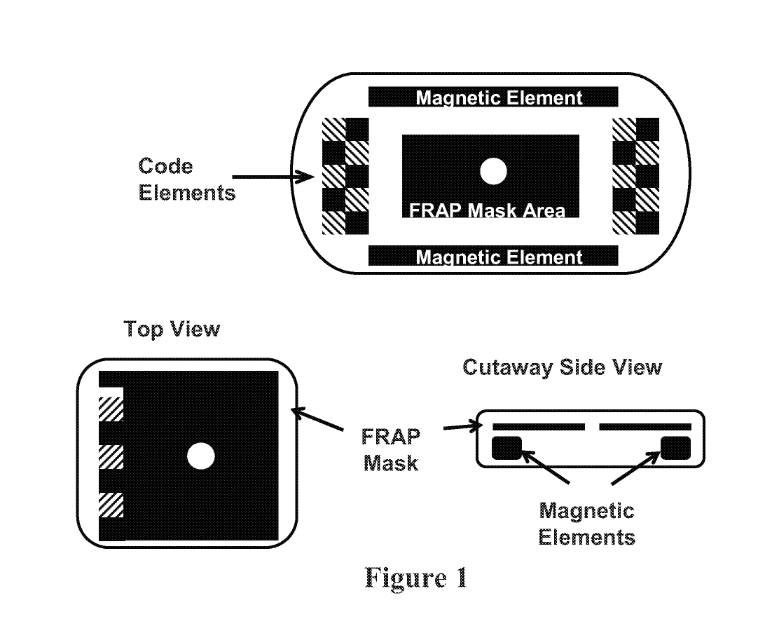

FIG. 1 shows a schematic examples of microdevices containing FRAP Mask, coding pattern, and magnetic elements. Lower left panel illustrates FRAP Mask that includes coding pattern.

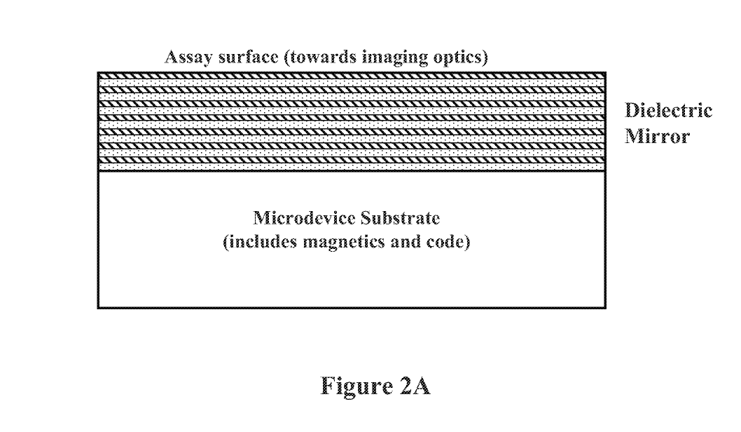

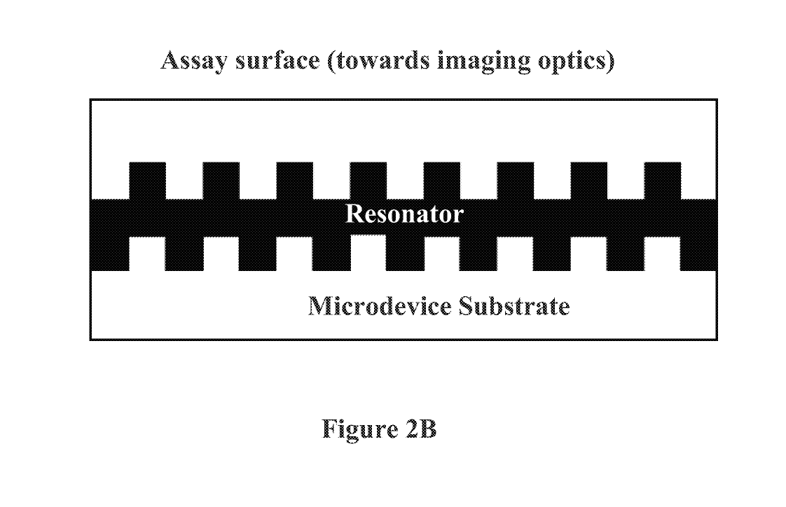

FIG. 2 shows examples of microdevices containing fluorescent enhancement features. Panel A: Side view schematic drawing of exemplary dielectric mirror. Example has 14 layers consisting of alternating low and high refractive index materials. The reflective and transmissive properties of the mirror can be selected so that the bleaching beam will pass the top layer allowing selective photobleaching. Similarly, the fluorescent signal will be reflected at the top surface. Panel B: Cutaway side view schematic of a microdevice containing an evanescent resonator.

FIG. 3 shows schematic example of portion of an arraying chip containing a masking layer. Panel A: Cutaway side view. Panel B: Top view. Black represents masked regions.

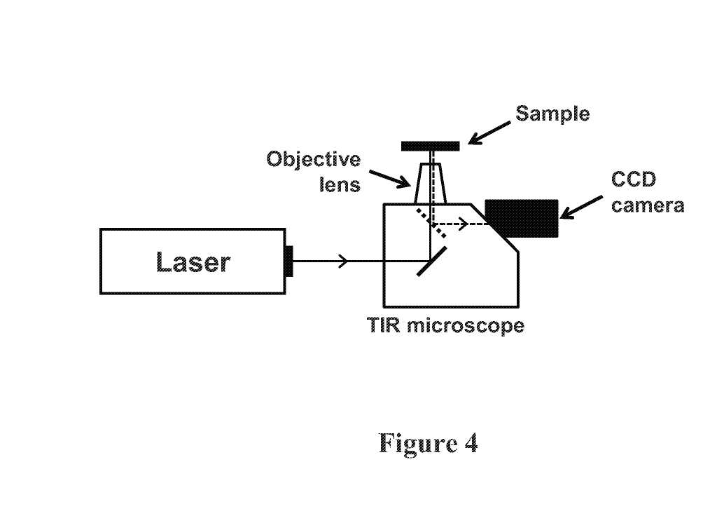

FIG. 4 shows a schematic of traditional microscope based FRAP configuration using a laser and an inverted total internal reflection fluorescence microscope. The laser is reflected up through the objective during the photobleaching phase. After photobleaching, signal is acquired from the same side of the sample as photobleaching.

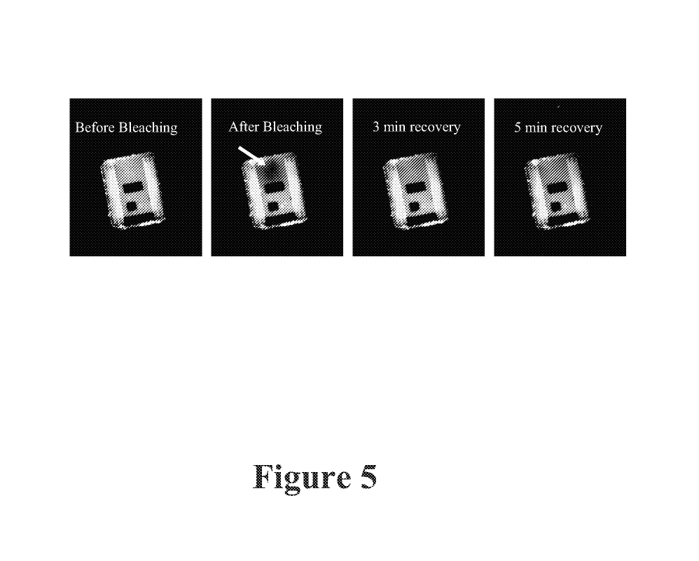

FIG. 5 shows FRAP experiment on a single microdevice using a conventional microscope approach. A series of microscope images of a microdevice containing a SLB described in the text. A white arrow has been added to the second frame from left to point to the photobleached region. The photobleached area appears black and lightens as the fluorescence recovers. These results demonstrate that SLBs can be created on microdevices.

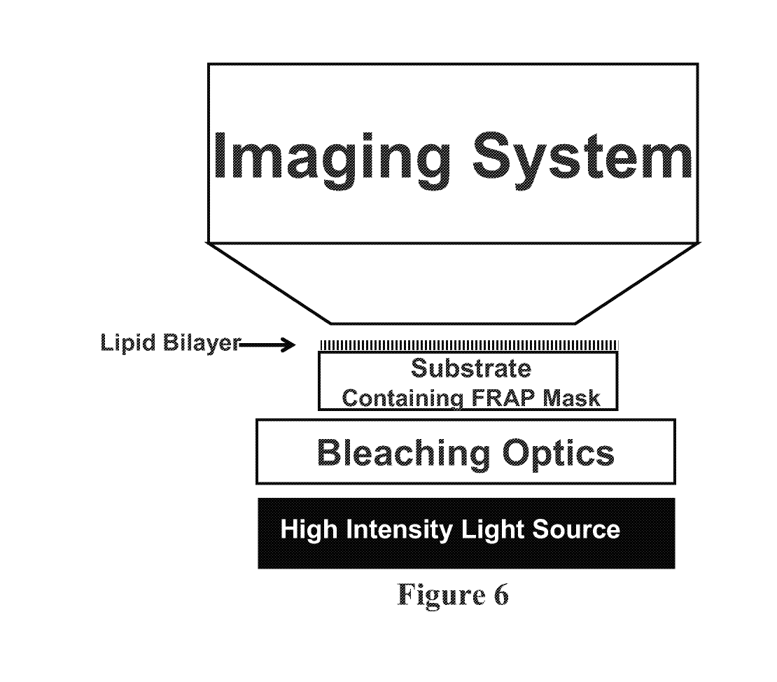

FIG. 6 shows a schematic example of FRAP configuration using a FRAP Mask. For photobleaching, light from high intensity light source passes through the bleaching optics (e.g., filters lenses, mirrors, etc.) and through the substrate that contains FRAP Mask. FRAP data is acquired from the other side of the substrate (top surface) by means of the imaging system.

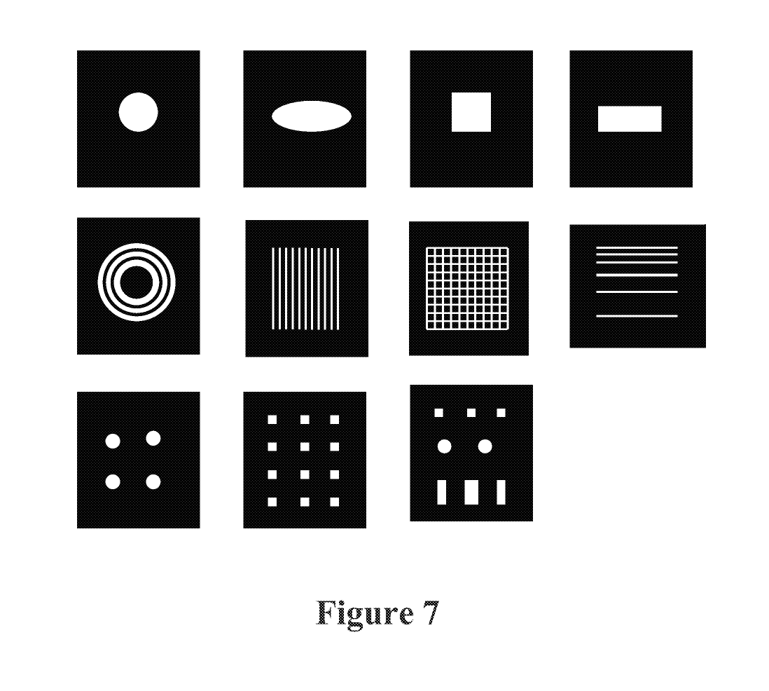

FIG. 7 shows a schematic showing exemplary FRAP Mask designs, including single and multiple geometric shapes, concentric rings, lines with uniform and non uniform distributions, and crossing lines. Transmissive areas (areas to be bleached) are shown in white.

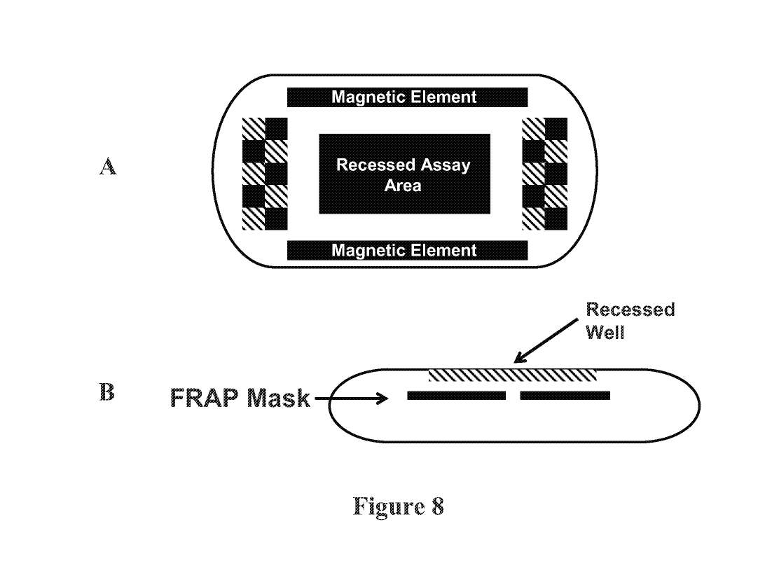

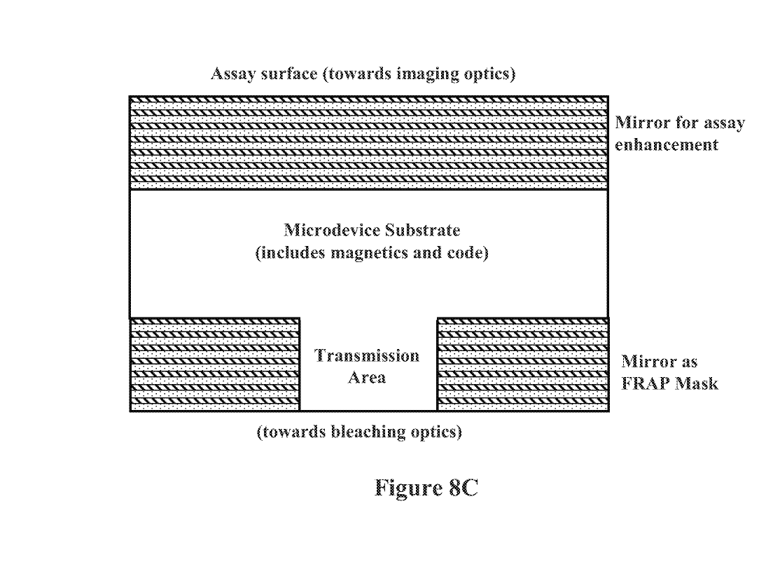

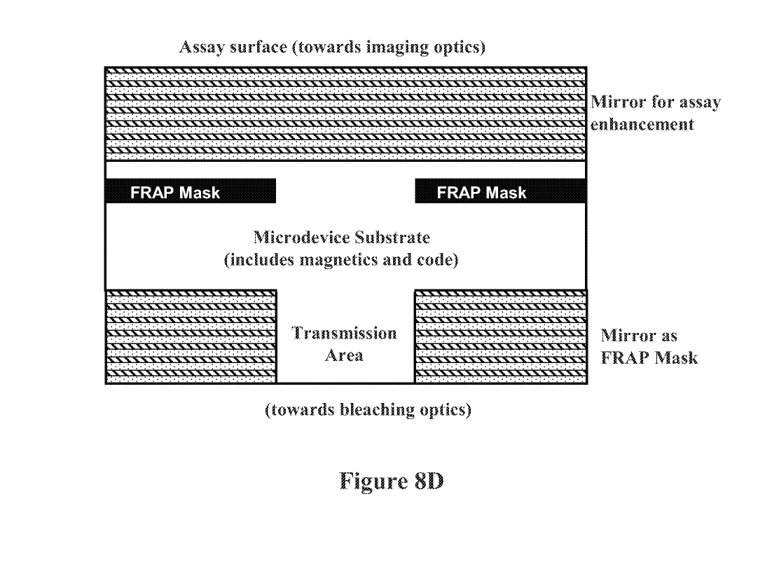

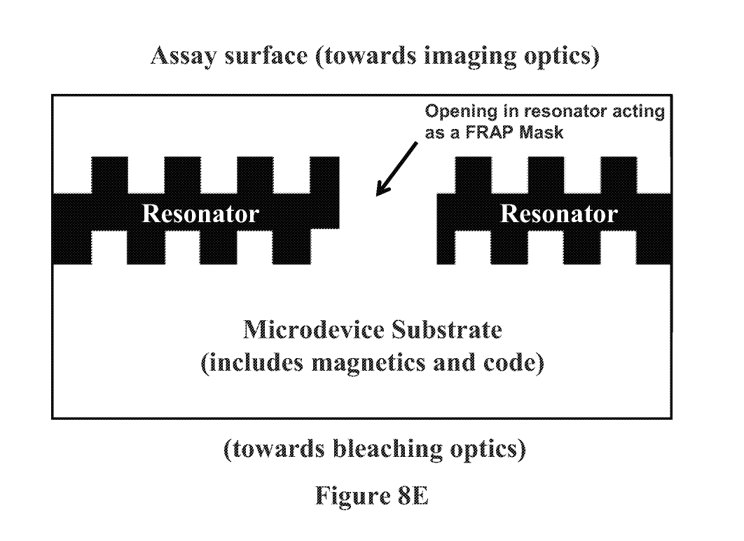

FIG. 8 shows a schematic of microdevices containing FRAP Masks and additional features including optical codes, magnetic elements and wells. Panel A: Top view. Panel B: Cutaway side view. Panel C: Cutaway side view of microdevice containing dielectric mirrors for assay enhancement and as a FRAP Mask. Panel D: Cutaway side view of microdevice containing dielectric mirrors for assay enhancement and as a FRAP Mask and an additional FRAP Mask. Additional FRAP Mask can be composed of any light transmission blocking or light transmission reducing material including mirrors or resonators. Panel E: Cutaway side view of microdevice containing an evanescent resonator for assay enhancement and as a FRAP Mask.

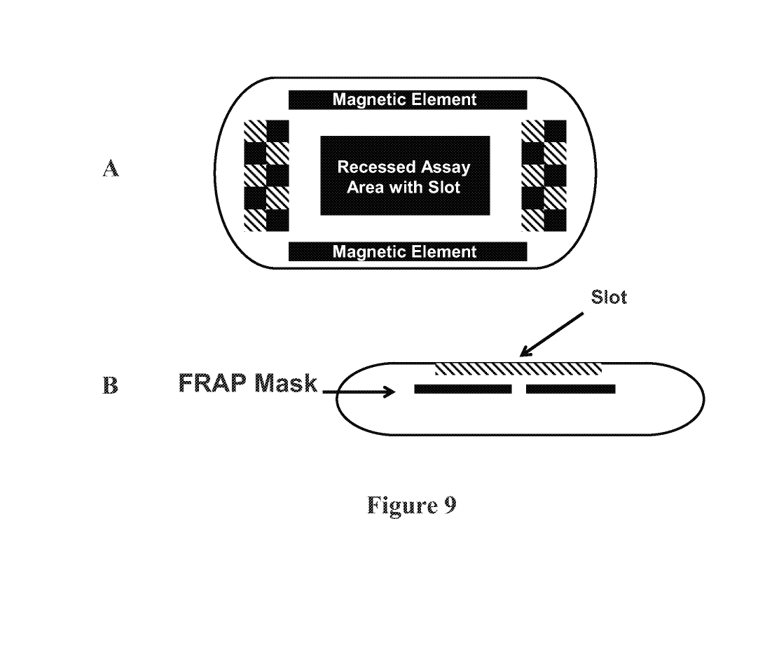

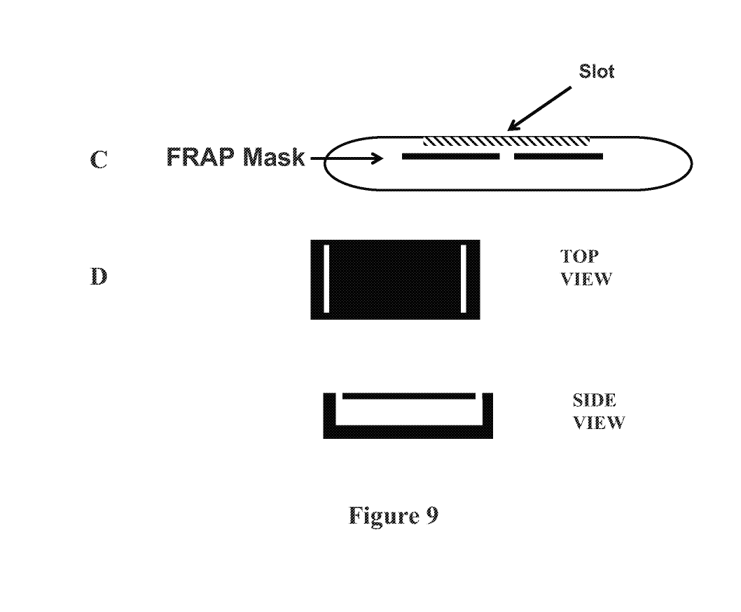

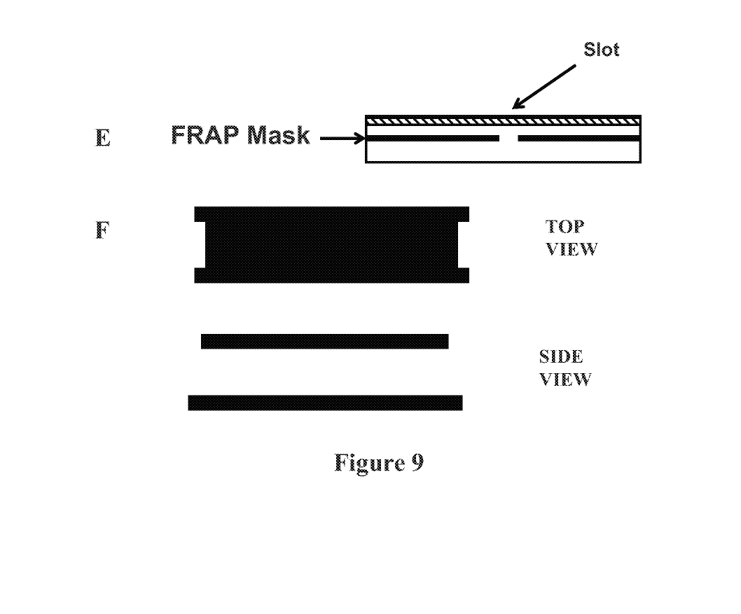

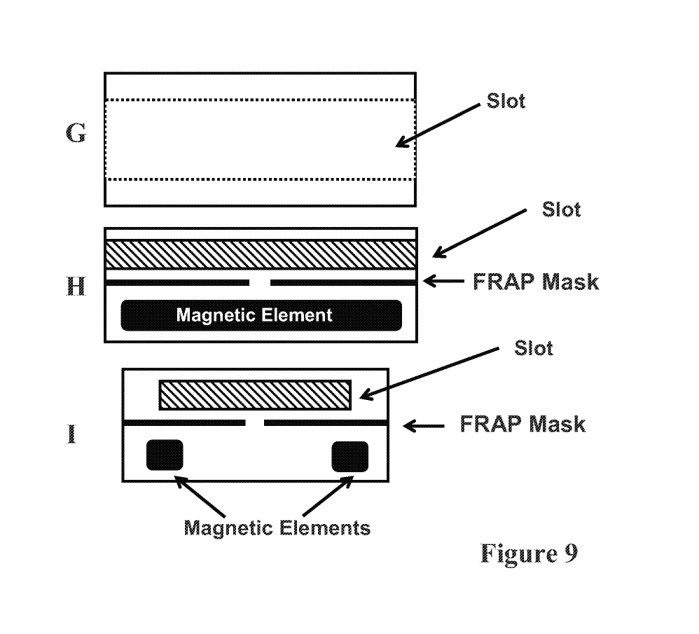

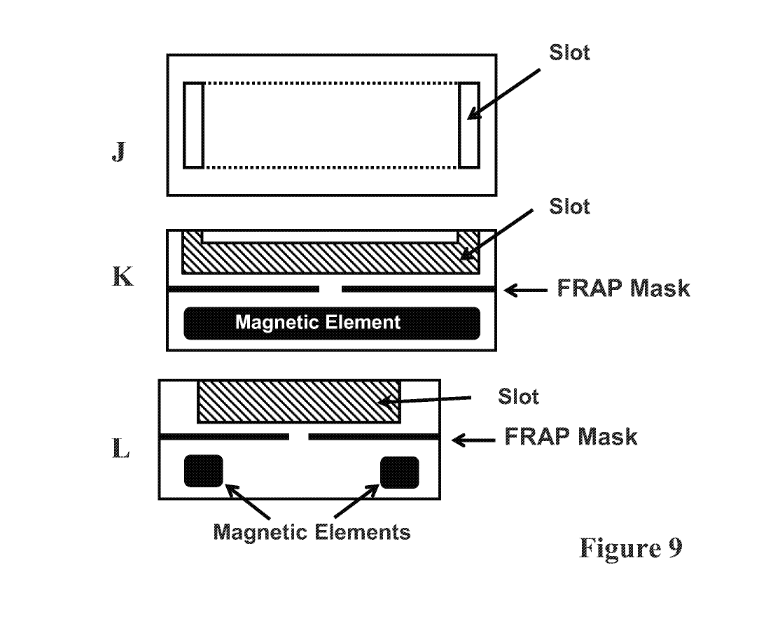

FIG. 9 shows a schematic of microdevices containing FRAP Masks and slots. Panel A: Top view of a microdevice containing a recessed assay area with a slot. Panel B: Cutaway side view of microdevice showing FRAP Mask, magnetic elements, and slot. Panel C: Cutaway side view of a microdevice containing a slot. Panel D: Top and cutaway side views of slot area in panel C; white areas represent areas without substrate, i.e. the slot and openings to the slot. Panel E: Cutaway side view of a microdevice containing a slot. Panel F: Top and cutaway side views of slot area in panel E; white areas represent areas without substrate, i.e. the slot and openings to the slot. Panel C: Top view of a microdevice containing a slot; dashed lines indicate position of slot below surface. Panel H: Cutaway side view cut through length; left to right) of the microdevice in panel G. Panel I: Cutaway side view (cut through width; top to bottom) of the microdevice in panel G; for image clarity width is shown twice that of panel G. Panel J: Top view of a microdevice containing a slot; dashed lines indicate position of slot below surface. Panel K: Cutaway side view (cut through length; left to right) of the microdevice in panel J: Panel L: Cutaway side view (cut through width; top to bottom) of the microdevice in panel J; for image clarity width is shown twice that of panel J.

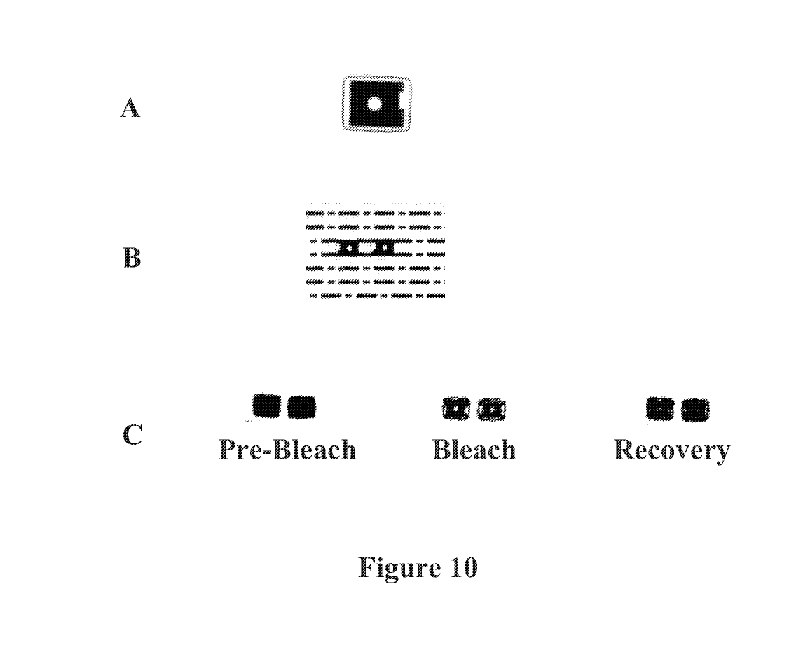

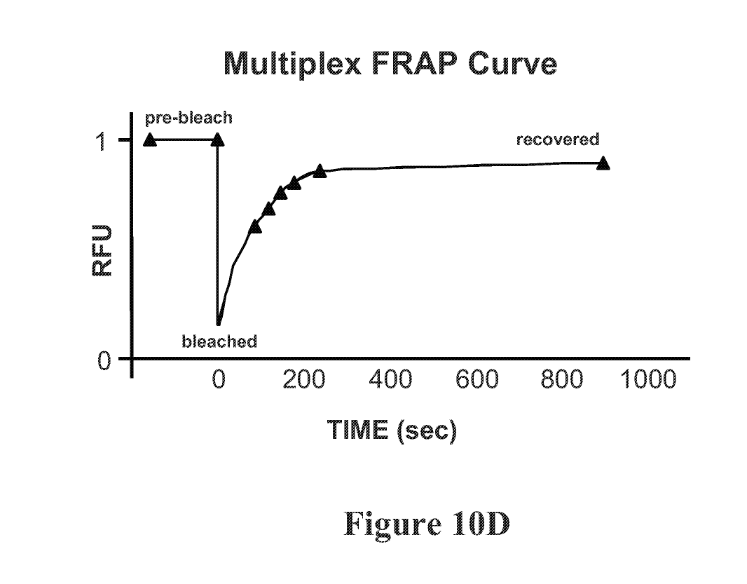

FIG. 10 shows a multiplex FRAP on arrayed microdevices where each microdevice contains a FRAP Mask. Panel A: a transmission microscope image of an exemplary microdevice containing a FRAP mask, magnetic elements, and an optical code (the cut out on the right-hand-side of microdevice). Microdevice is 60×75×4 micron. Panel B: two microdevices of the type shown in Panel A arrayed on an arraying chip; image shows a portion of arraying chip imaged on a wide field of view imaging system (>4 mm) with illumination from below. Panel C: Two microdevices of the type shown in Panels A and B arrayed on an arraying chip and subject to FRAP analysis. SLBs were produced on the microdevice surface by the spontaneous fusion of Small Unilamellar Vesicles (SUVs) prepared from a 97:3 mixture of 1-Palmitoyl-2-oleoyl-sn-glycero-3-phosphocholine and 1,2-dioleoyl-sn-glycero-3-phosphoethanolamine-N-(carboxyfluorescein). Photobleaching was by means of a liquid light guide positioned below arraying chip. The light source was a metal halide lamp. The same microdevices are shown in Pre-Bleach, Bleach, and Recovery images and microdevices and arraying chip are imaged on same system as the image in Panel B but with epi-fluorescent illumination system (illumination from above). In order to more clearly show the bleaching and recovery the images have been digitally inverted and contrast enhanced (converted to a black and white image). Image inversion results in the bleached regions appearing white in the image and fluorescent regions appearing black. Bleach image corresponds to 40 seconds after bleaching pulse and recovery corresponds to 150 seconds. Panel D: Exemplary FRAP curve obtained from data of the type shown in Panel C. Data points are average of measurements made on four separate microdevices. Minimum was determined from a single exponential fit of the recovery data. These results indicate that multiplex FRAP can be carried out using microdevices containing FRAP Masks.

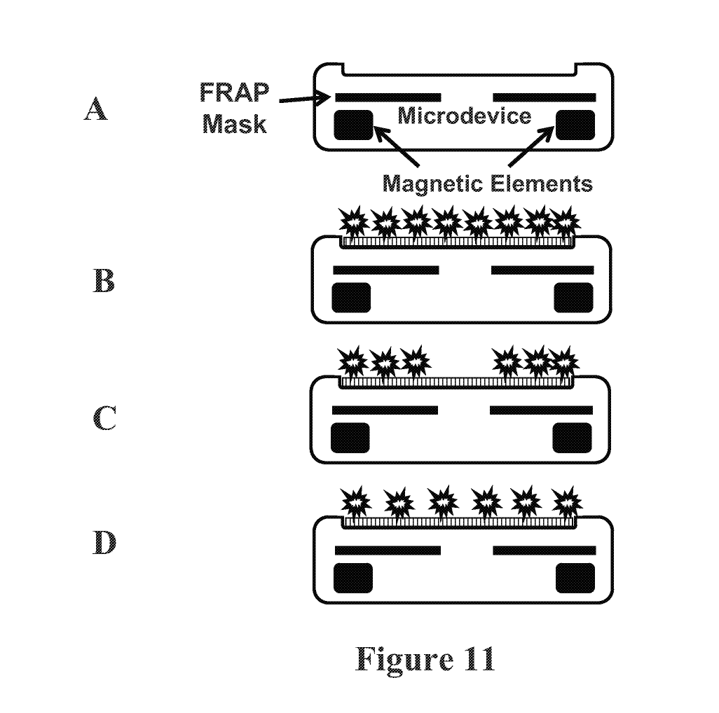

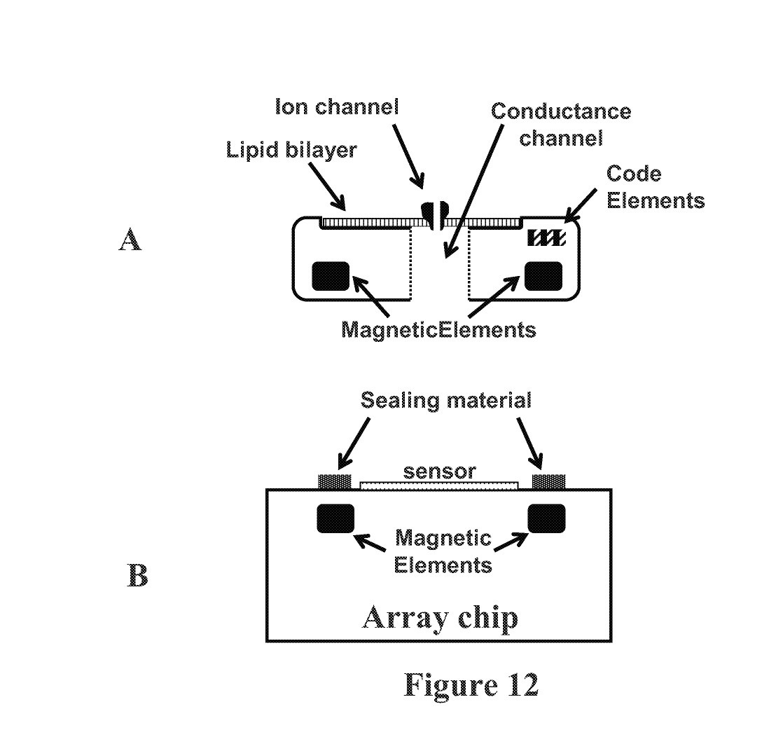

FIG. 11 shows an exemplary FRAP assay procedure using microdevices. All panels show cutaway side views. Panel A: Microdevice with a well and FRAP Mask. Panel B: Microdevice after lipid bilayer is formed in the well. Stars indicate fluorescently labeled lipids. Panel C: Microdevice after bleaching, illustration shows that the fluorophores directly above the hole in the FRAP Mask have been destroyed. Panel D: Microdevice after recovery, illustration shows that the fluorophores directly above the hole in the FRAP Mask have been replenished by diffusion of fluorescently labeled lipids in the bilayer,

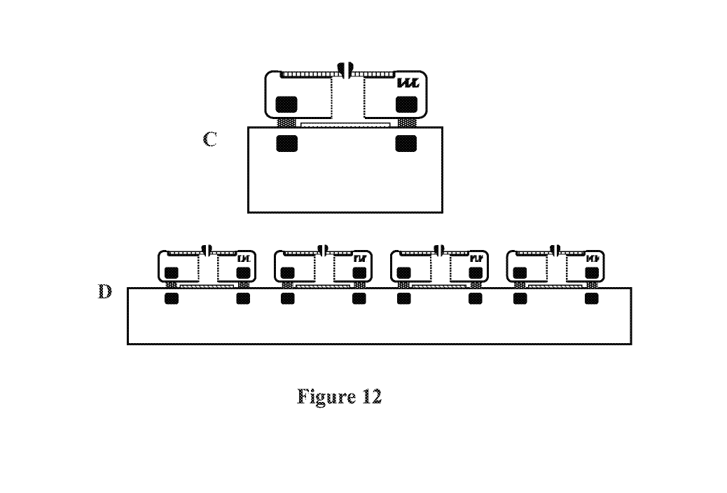

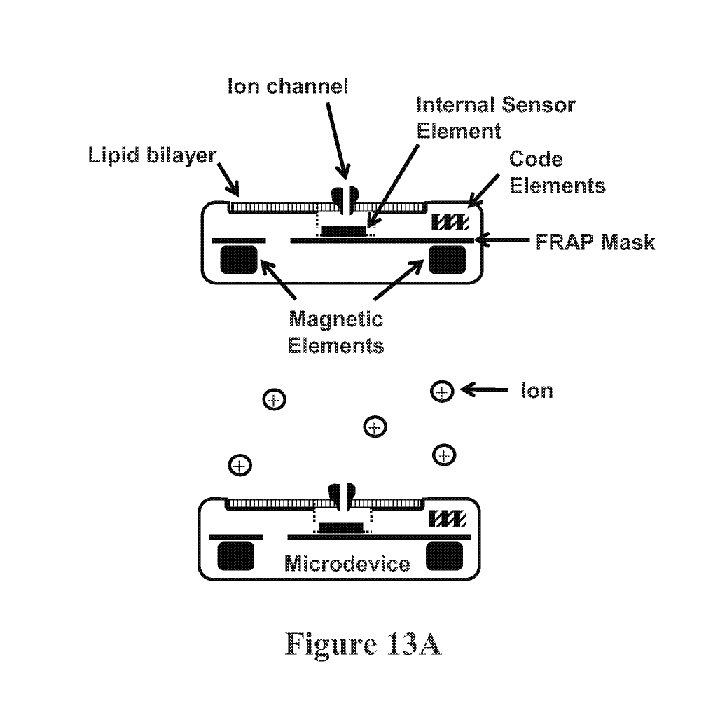

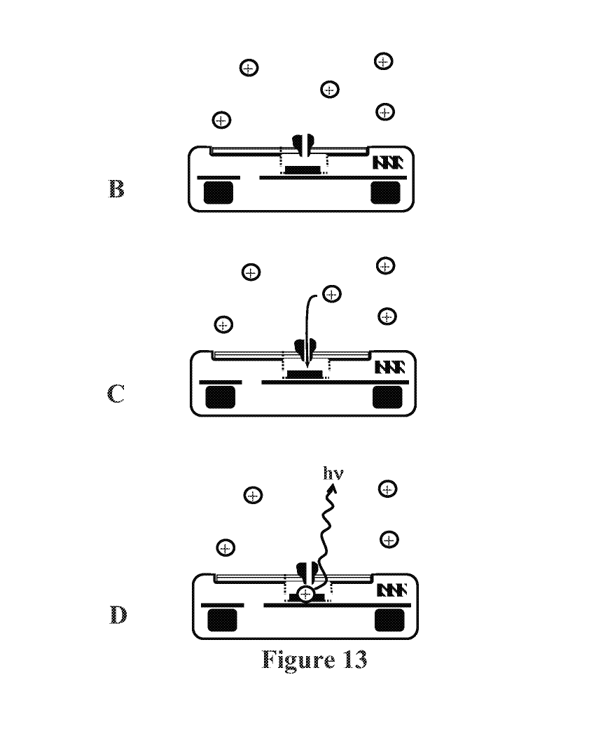

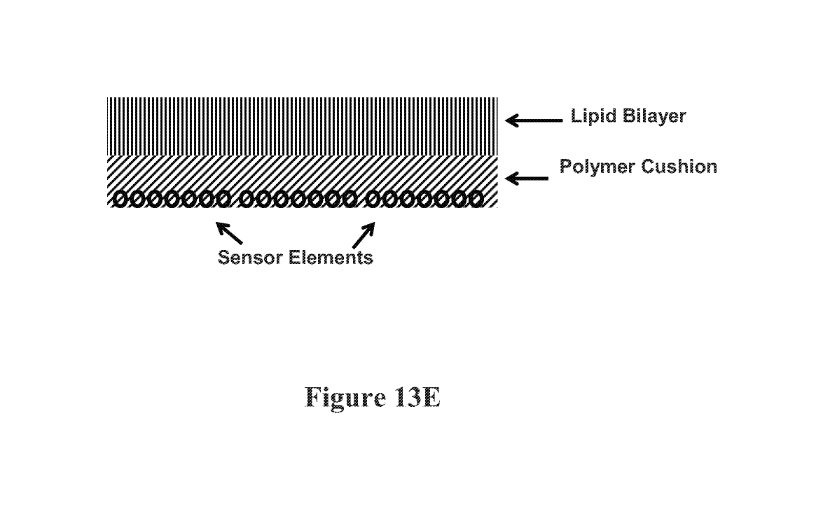

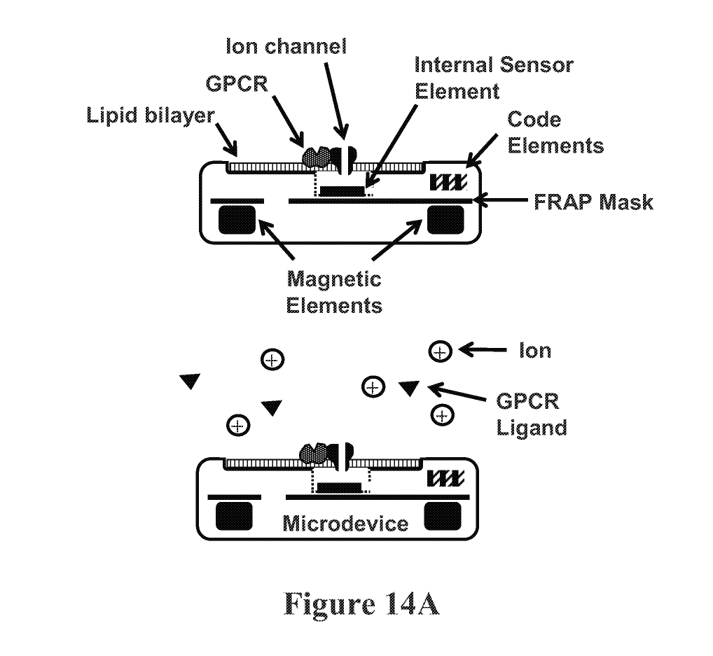

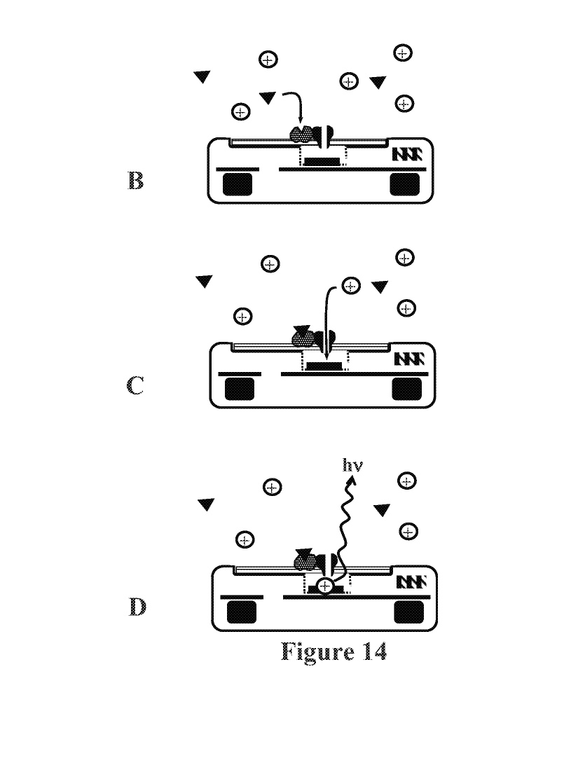

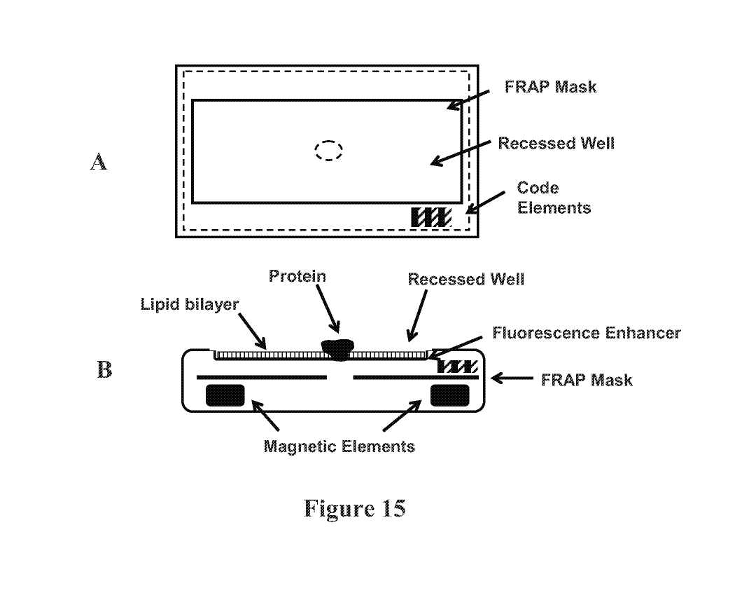

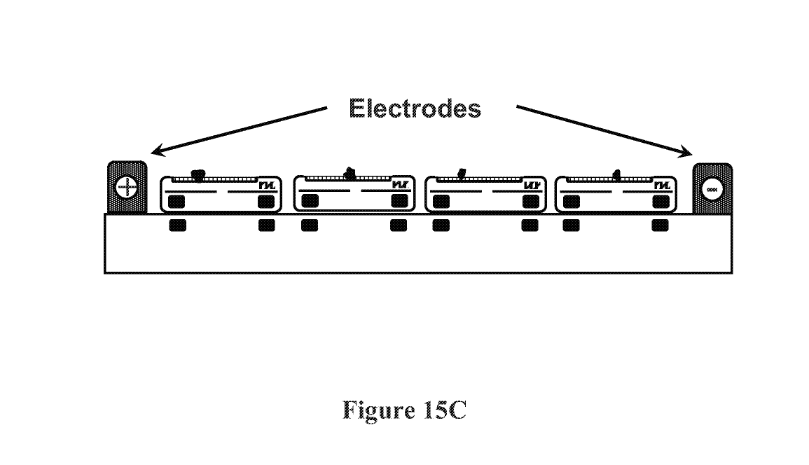

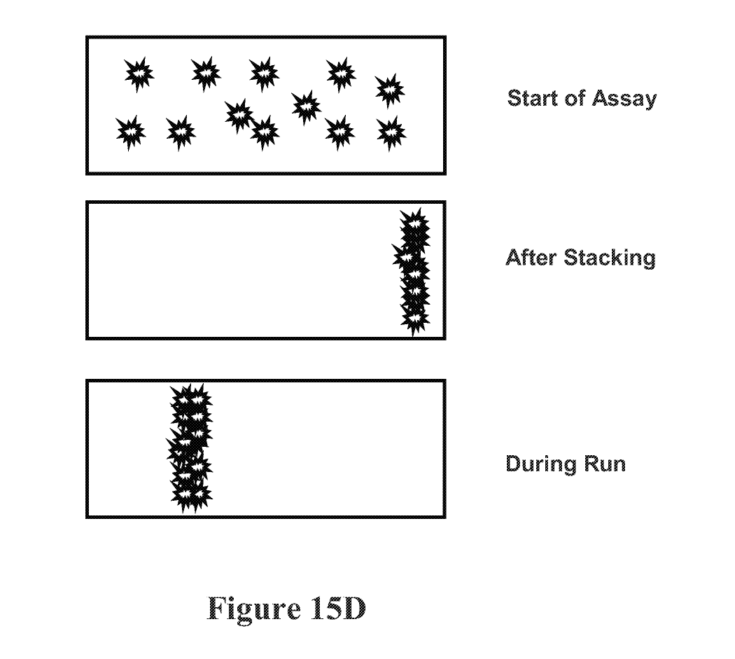

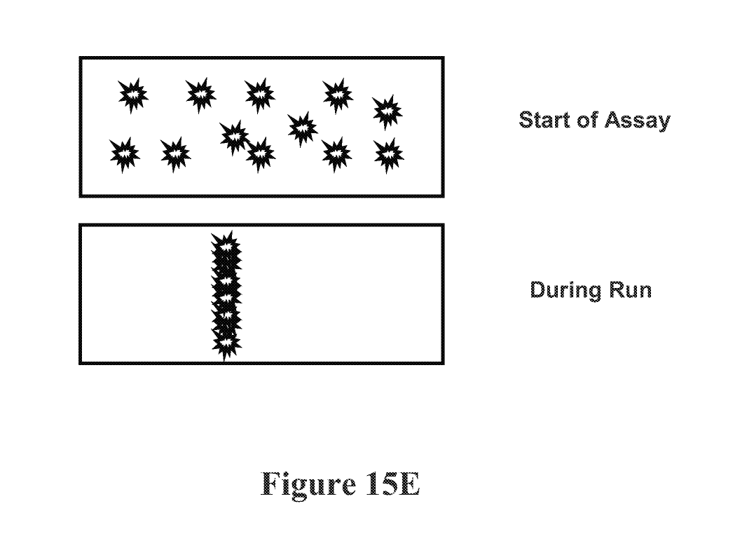

FIG. 12 shows an exemplary ion channel assay procedure using microdevices with arraying chip sensors. All panels show cutaway side views. Panel A: Microdevice with a well, lipid bilayer containing an ion channel protein, and a conductance channel. Panel Segment of an arraying chip capable of forming a sealed compartment underneath a microdevice. The arraying chip surface contains sensors for detection of small molecules and biomolecules within the sealed compartment. Panel C: Microdevice forming a seal on top of arraying chip. Panel D: View of a multiplexed array of sealed microdevices. Arraying chip based sensor can be chemical or electronic in nature.

FIG. 13 shows an exemplary ion channel assay procedure using microdevices with internal sensors. All panels show cutaway side views. Panel A: Microdevice with a well, lipid bilayer containing an ion channel protein, and a sensor element. Panel B: Start of assay; addition of ions that can pass through channel. Panel C: Ions pass through channel. Panel D: Ions interact with sensor triggering response leading to optical signal. Panel E: Example of lipid bilayer with sensor element. Sensor elements are denoted by round circles. While illustrations in panels A-D show the sensor region as a small area below the lipid bilayer, a sensor region can correspond to the entire area of the lipid bilayer or any portion.

FIG. 14 shows an exemplary GPCR assay using microdevices with internal sensors as shown in FIG. 13. All panels show cutaway side views. Panel A: Microdevice with a well, lipid bilayer containing GPCR and ion channel proteins, and a sensor element. Panel Start of assay; addition of ions that can pass through channel and ligand that binds GPCR. Panel C: Ligand binds GPCR allowing ions to pass through channel. Panel D: ions interact with sensor triggering response leading to optical signal.

FIG. 15 shows an exemplary electrophoresis separation assay using microdevices. Panel A: Top view of microdevice with a well, magnetic elements, code elements, fluorescence enhancement element, and a recessed well. Panel B: Cutaway side view of microdevice containing lipid bilayer in well and protein in bilayer. Panel C: Side view of arrayed microdevices on arraying chip with electrodes on each end of arraying chip to apply electric field across surface of arraying chip; suitable electrolyte solution surrounds microdevices. Panel D: Electrophoresis separation on microdevices; top view of well region showing protein movement. Stars indicate fluorescently labeled protein of interest. At start of assay protein is uniformly distributed in bilayer. After stacking protein forms tight band. During run band moves through bilayer. Panel E: Electrophoretic-electroosmotic focusing separation on microdevices; top view of well region showing protein movement. Stars indicate fluorescently labeled protein of interest. At start of assay protein is uniformly distributed in bilayer. During run proteins focus into narrow bands.

### A. System for Lipid Array Formation

A variety of microfabricated assay platforms exist. One such system described based on arraying magnetic encoded particles has been described in detail in (U.S. Pat. Nos. 7,718,419 and 7,811,768; US Patent Applications 20080176762 and 20080176765; Herold et al., 2008). This system forms the foundation for the inventive elements disclosed here. This section summarizes and repeats some of the details disclosed in those earlier publications as they apply to the inventions presented herein.

Before summarizing these details, it is important to note that while the system discussed involves individual microdevices, many of the inventions presented in later sections could also be applied to lame fixed arrays. Because the microfabrication methods utilized to produce these microdevices result in the production of a fixed array format prior to the release of the individual microdevices, fixed array applications can be considered a trivial extension or subset of the proposed inventions. In some instances fixed array applications are explicitly noted, but the application on fixed arrays of inventions presented here on microdevices should be apparent to those skilled in the art.

Microdevices containing a preferential axis of magnetization can be “arrayed” on a substrate support, or “arraying chip”, that consists of an array of magnetizable material. Such array chips are discussed in U.S. Pat. No. 7,682,837 and their use in arraying microdevices containing a predetermined preferential axis of magnetization are presented in US Patent Application 20080176762 and Herold et al, 2008, Positioning of magnetic elements in the substrate of the microdevice enables the face-up face-down orientation of microdevices to be controlled.

Reading system for microdevices is comprised of, but not limited to, a light source, an optical system, optical filters, and a sensor such as a CCD, CMOS, or PMT device. Examples of such optical reading systems include commercially available microarray scanners, microplate scanners, and fluorescent microscopes.

Microdevice, Detailed Description

One embodiment of the inventive subject matter includes a flat or substantially flat nonmagnetic substrate containing a pattern of “magnetic” features, as described in U.S. Pat. Nos. 7,718,419 and 7,811,768, and US Patent Applications 20080176762 and 20080176765. Magnetic features can be made out of any ferromagnetic, ferrimagnetic, or paramagnetic material. Preferred materials are high permeability ferromagnetic materials such as CoTaZr or NiFe. Preferably such features are bar shapes that have a preferential axis of magnetization. The substrate can be composed of any material that is flat or near flat. Preferred materials include Silicon, Silicon Dioxide, Silicon Nitride, glass, and plastics.

The microdevice comprises a magnetizable substance wherein said microdevice has a predetermined preferential axis of magnetization. Additional features can be incorporated into the microdevice, including, but not limited to, photorecognizable coding patterns. Such photorecognizable coding patterns include but are not limited to 1D barcodes, 2D barcodes, microdevice shape, and combinations of barcodes and shapes. FIG. 1 shows some schematic examples of microdevices. The properties of such microdevices containing photorecognizable coding patterns are enumerated in U.S. Pat. No. 7,015,047 and US Patent Applications 20080176762 and 20080176765. As detailed in those patent applications:

The microdevices can have any shape. They can have planar surfaces, but they need not have planar surfaces; they can resemble beads. Flat disks are a preferred implementation. Microdevices shaped as circles, squares, ovals, rectangles, hexagons, triangles, and irregular shapes are all amenable to the magnetic assembly arraying process. The microdevices can be of any suitable dimension(s) For example, the thickness of the microdevice can be from about 0.1 micron to about 500 microns. Preferably, the thickness of the microdevice can be from about 1 micron to about 200 microns. More preferably, the thickness of the microdevice can be from about 1 micron to about 50 microns, in a specific embodiment, the microdevice is the form of a cuboid having a surface area from about 10 squared-microns to about 1,000,000 squared-microns (e.g., 1000 micron by 1000 micron). In another specific embodiment, the microdevice is an irregular shape having a single-dimension from about 1 micron to about 500 microns. Any suitable magnetizable material can be used in the present microdevices. In one example, the magnetizable substance used is a paramagnetic substance, a ferrimagnetic substance, a ferromagnetic substance, or a superparamagnetic substance. The magnetizable substance can be situated completely inside (encapsulated) the non-magnetizable substrate comprising the microdevice, completely outside yet attached to the non-magnetizable substrate comprising the microdevice, or anywhere in between. Preferably the magnetizable substance is patterned, for example using micromachining or lithographic techniques, so that its three-dimensional shape is a known feature of the design of the microdevice. Because the microdevices are used to carry out assays in a liquid array format, it is advantageous that they can be conveniently aliquoted or dispensed using conventional liquid and bead handling devices (e.g., pipettors). Consequently, it is desirable that they do not self-associate in the absence of a magnetic field. Therefore, low remanence (i.e., magnetization left behind in a medium after an external magnetic field is removed) is a desirable quality. Cobalt alloys such as CoTaZr and iron oxides (Fe₃O₄) are preferred examples of magnetic materials that meet this criterion. In a preferred embodiment, microdevices include a non-magnetic substrate composed of multiple layers. This nonmagnetic substrate can contain other features including optical encoding patterns and wells. Additional features can be included and any of the wide range of features compatible with planar microfabricated devices such as those used in Micro-Electro-Mechanical Systems (MEMS) can be incorporated into the non-magnetizable substrate of the microdevice.

Preferred embodiments include the use of wells and recessed areas that are optimized for particular applications. For example, when attaching a single cell to a microdevice it is desirable that the well be larger than the cell but small enough to prevent two cells from residing in the well. Such recessed areas can correspond to nearly the entire surface of a microdevice or only a small portion. Additionally, a microdevice can contain multiple recessed areas. Examples of such recessed areas and their uses are presented in subsequent sections.

Fluorescence Enhancement

For use in fluorescence-based assays it is desirable for the microdevices to contain fluorescence enhancing structures. Fluorescence signal can be enhanced by altering the environment of the fluorophore by altering the properties of the underlying support, often referred to as surface enhanced fluorescence (SEF) Many of these approaches have led to specialized types of fluorescence microscopy and plasmonic-based optical sensors. There are a wide variety of approaches that have been used (reviewed in Fort & Gresillon, 2008; Lakowicz et al. 2008; Ray et al. 2009) to enhance fluorescence signal. In recent years many of these approaches have focused on the use of nano-scale features and plasmonic coupling of surfaces. Plasmonic detection systems and waveguide enhancers have found application in specialized types of fluorescence microscopy and biosensor design. Many of these types of devices require the use of specialized excitation and detection geometries. Only a handful of SET procedures have either been applied to or are readily adaptable to use on microarray platforms. Two preferred embodiments of fluorescence enhancement technologies for incorporation into microdevices are waveguides and mirrors. Such enhancement technologies can extend over one or more surfaces of a microdevice. Additionally, microdevices can contain more than one enhancement element.

One type of mirror is a metal mirror. Metal mirrors offer a variety of advantages including the possibility of further signal enhance by means of nanopatterning, a process often termed metal-enhanced fluorescence (MEF) (reviewed in Asian et al. 2005; Fort & Grésillon 2008; Lakowisz et al. 2008). Microdevices described in U.S. Pat. Nos. 7,718,419 and 7,811,768 and US Patent Applications 20080176762 and 20080176765 already can be considered to contain metal mirrors as reflective metal layers including encoding and magnetic layers function as mirrors.

A preferred enhancement method for use in microdevices is a dielectric mirror. The dielectric mirror consists of a series of alternating layers of low and high refractive index dielectric materials. The design of such mirrors in large planar substrates is well established. Detailed procedures and equations for their design are in the literature (Baumeister 2004; Barritault et al. 2004; Southwell 1999; U.S. Pat. No. 6,008,892). The mirror enhancement technology is widely used (including both dielectric and metal mirrors) on microscope slides and commercially available mirror slides include Nexterion® HiSens Slides (Schott) and Amplislides (Genewave) which are produced using multilayer dielectric thin films. Such dielectric mirrors can be used to enhance fluorescence signal at a particular wavelength or range of wavelengths. They can also be used to decrease fluorescence at a particular wavelength or range of wavelengths. In a preferred embodiment, the microdevices contain dielectric mirrors to modulate fluorescence intensity. In a further preferred embodiment both top and bottom surfaces of the microdevice contain a dielectric mirror. In addition to modulating the fluorescence intensity such mirrors on the surface of the microdevices serve to minimize any metal mirror effects or internal reflections that can arise from reflections off of metal layers within the microdevice. A further advantage of this process is that opposite faces of the microdevice can be configured using dielectric mirrors to have either the same fluorescence enhancement or different enhancements but of known or predetermined (i.e., through proper design of each mirror) amount. Such differences can be used to increase dynamic range or to screen internal metal mirrors within the microdevice thereby allowing microdevice orientation e.g. face-up and face-down) to be distinguishable (or indistinguishable) by fluorescence intensity independent of any microdevice internal structures. In preferred embodiments the low refractive index material in the dielectric mirror is silicon dioxide. Preferred embodiments for the high refractive index material include titanium dioxide, hafnium oxide, tantalum pentoxide, aluminum oxide, silicon nitride and metal oxides.

Another type of fluorescence enhancement feature is the planar waveguide (PWG) consisting of a planar substrate with a thin (typically 100-200 nm) wave-guiding layer. Such devices have been incorporated into large planar surfaces (U.S. Pat. Nos. 5,959,292 and 6,078,705). Light propagating along the wave-guiding layer generates a strong evanescent field (reviewed in Schmitt et al. 2008; Mukundan et al, 2009). This field is able to penetrate up to ˜200 nm into the surrounding medium. Fluorophores within the range of the evanescent field are excited leading to enhanced fluorescence. This allows selective enhancement of fluorescence near the surface of the waveguide, facilitating the ability to distinguish fluorophores on surface from those in the surrounding solution. The commercial Zeptosens ZeptoMARK chip uses this technology (Duveneck et al, 2002; Pawlak et al. 2002). Zeptosens uses a grating to direct excitation light into the waveguide. A similar device called an evanescent resonator consists of a planar grating that serves both to direct excitation light as well as to propagate an evanescent field (Neuschäfer et al. 2003; Neuschäfer et al. 2005). Schematic drawings of an evanescent resonator and dielectric mirrors are shown in FIG. 2 along with schematic examples of microdevices containing these enhancement elements. The evanescent resonator is compatible with epi-fluorescent observation systems as the angular dependence of the emission can be easily altered by varying the thickness of metal oxide layer (Neuschäfer et al, 2003).

In a preferred embodiment, microdevices contain multiple enhancement elements, for example a set of mirrors or a combination of mirrors and waveguides. Such combinations can be used to extend the dynamic range of an assay allowing multiplex assays that differ by orders of magnitude to be measured simultaneously within dynamic range of the detection system (e.g. CCD, CMOS, or PMT); for example 4 regions that differ in enhancement by a factor of 10 comprising a destructive interference mirror (0.1×), a non-enhancing surface (1×), an enhancing mirror (10×), a PWG (100×). Additionally, multiple enhancement elements can be optimized for different wavelengths.

As discussed below such enhancement and modulation technologies are advantageous in lipid-based fluorescence assays. It will be readily apparent to those skilled in the art that many more applications of such enhancement technologies on microdevices beyond those involving lipids are possible, including a wide range of non-lipid containing fluorescence measurements, such as DNA, RNA, proteins, and small molecules.

Arraying Chip, Detailed Description

As described in US Patent Applications 20080176762 and 20080176765 and U.S. Pat. No. 7,682,837 the arraying chip is comprised of both magnetic and non-magnetic material. In its most basic form an arraying chip is an arraying substrate containing magnetizable magnet elements that have a predetermined preferential axis of magnetization. Any suitable magnetizable material can be used in the arraying chip. In one example, the magnetizable substance used is a paramagnetic substance, a ferromagnetic substance, a ferrimagnetic substance, or a superparamagnetic substance. Preferably, the magnetizable substance is a transition metal composition or an alloy thereof such as iron, nickel, copper, cobalt, manganese, tantalum, and zirconium. In a preferred example, the magnetic substance is a metal oxide. Further preferred materials include NiFe and cobalt. Additional preferred materials include alloys of cobalt such as CoTaZr, CoFe, and CoNiFe. Preferably such features are bar shapes that have a preferential axis of magnetization. In many applications, the ability to impart residual magnetization into the magnetic elements of the arraying chip is a desirable quality. Similar to the microdevice, the magnetizable substance in the arraying chip can be situated completely inside (encapsulated) the non-magnetizable substrate comprising the arraying chip, completely outside yet attached to the non-magnetizable substrate comprising the arraying chip, or anywhere in between. A preferred embodiment places the magnetic elements on top of a glass substrate and encapsulates them with silicon dioxide such that the silicon dioxide forms a planar or substantially planar surface. The surface area of an arraying chip can range from less than 1 mm² to greater than 100,000 mm². FIG. 10B shows a small portion of an exemplary arraying chip (˜0.1 mm²), the full surface area of that particular arraying chip being 100 mm². In preferred embodiments the predetermined axis of magnetization of the arraying chip is parallel to the arraying surface (the surface upon which microdevices are arrayed) of the arraying chip.

Although most or all of the examples presented in this application use an arraying chip containing CoTaZr bars that have low remanence and low coercivity, these properties are not necessary for the assembly of magnetic arrays. Since high remanence will cause microdevices to magnetically assemble into chains or clumps in the absence of an external magnetic field, in general, it is not desirable for the microdevices to contain such; although, it can be desirable that the magnetic elements contained within the arraying devices have said qualities in order to allow assembled arrays to remain intact once the arraying field is removed. However, arrays can also be analyzed dry and the adhesive forces between the flat microdevices and the surface of the arraying chip will be sufficient to hold the arrayed microdevices in place under most experimental conditions in the absence of a continuously applied external magnetic field. These adhesive forces can be enhanced by drying under condition or in the presence of reagents where drying leaves a film over the surface. Since it is generally desirable to keep lipid containing surfaces hydrated a preferred embodiment is that the magnetic elements in the arraying chip be composed of a magnetic material with higher remanence, such materials include CoFe.

Surface properties can also be modulated through chemical treatments. For example, application of slimes can be used to generate hydrophilic (including charged surfaces) or hydrophobic surfaces, which will either favor or disfavor adhesion (depending on the solution conditions). Such approaches are well established in the art of surface chemistry and microfabrication.

The non-magnetizable substrate can be comprised of any suitable material including silicon, silicon dioxide, silicon nitride, plastic, glass, ceramic, polymer, metal (e.g., gold, aluminum, titanium, etc.) or other similar materials or combinations of such materials. In a preferred example the material is silicon dioxide. In another preferred example the material is glass. The substrate can comprise a single layer or it can comprise multiple layers. The arraying chip substrate can, but need not be, planar or substantially planar. There can exist indentations in the arraying chip that allow for “seating” of the microdevices to assure exact alignment of said microdevices, which can be desirable for some applications. These indentations, for example, can have planar faces for seating of microdevices that are flat-ish, or they can be spherical for seating of beads or bead-like microdevices. In one preferred embodiment the indentations are designed to match the shape of individual planar microdevices, e.g. rectangular wells to hold rectangular microdevices of the type shown in FIG. 1. The arraying chip can contain additional features such as microchannels to enable delivery of reagents to arrayed microdevices. In a preferred embodiment arraying chips contain a masking layer complementary to the FRAP Mask in the microdevices, said masking layer reducing the amount of photobleaching light striking the microdevice to minimize heating as well as eliminate bleaching from the edges of the microdevices. FIG. 3 shows a schematic example of a masking layer within an arraying chip—when arrayed, microdevices would be positioned over the unmasked regions of the complementary mask. In preferred embodiments the non-magnetizable substrate is “substantially transparent” at the wavelength to be used for photobleaching. In preferred embodiments transmission of light at the photobleaching wavelength is at least 10 fold greater through the non-magnetizable substrate containing a masking layer complementary to a FRAP Mask than through the masking layer. In farther preferred embodiments transmission of light at the photobleaching wavelength is at least 100 fold greater through the non-magnetizable substrate containing a masking layer complementary to a FRAP Mask than through the masking layer.

The number of arraying sites per unit area is dependent on the size and spacing of the magnetic elements on the arraying chip. For example, arraying chips of the type shown in FIG. 10 displaying arrayed microdevices (the microdevices are 60×75 micron in size having a surface area less than 5000 micron²) can array approximately 100 microdevices per square millimeter (10,000 microdevices/cm²). In other embodiments where the microdevices are smaller the density can be much higher, exceeding 500,000 microdevices/cm².

While arrayed microdevices are typically distributed randomly on the arraying chip surface, they are not positioned at random locations but at specific arraying sites, which are predetermined locations on the arraying chip surface. Such specific positioning of arrayed microdevices on the arraying chip enables the proper alignment of the complementary masking layer within the arraying chip and a FRAP Mask within the microdevice. As shown in US Patent Applications 20080176762, microdevices can be positioned with submicron accuracy on an arraying chip. Additionally, this ability to precisely position microdevices on the arraying chip surface enables the arrayed microdevices to be precisely aligned with each other, an important advantage when using microdevices containing waveguides.

The arraying chip can contain additional features that are not necessarily required to facilitate the arraying process. Any of the wide range of features compatible with planar microfabricated devices can be incorporated into the non-magnetizable substrate of the arraying chip, such as those used in MEMS (for example as reviewed in Liu, C., Foundations MEMS, Pearson Prentice Hall, Upper Saddle River, N.J., 2006; Gad-el-Hak, M., MEMS (Mechanical Engineering), CRC Press, Boca Raton, 2006). A preferred example is microchannels. Such channels can be used to deliver and/or remove reagents and other materials such as microdevices from the arraying chip surface. Additional preferred examples include electronic and optical microsensors including those used in MEMS (for example as reviewed in Gardner, J. W. et al., Microsensors, MEMS, and Smart Devices, John Wiley & Sons, West Sussex, 2001).

In a preferred embodiment the arraying chip contains a series of separate arrays. Such arrays can be separated by channels or walls on the surface of the nomnagnetizable substrate or can only be divided by empty space. In the case of walls, the walls can be made of any material compatible with the substrate surface including silicon dioxide, silicon nitride, plastic, glass, ceramic, polymer, metal (e.g., gold, aluminum, titanium, etc) or other similar materials or combinations of such materials. A preferred embodiment is SU-8.

In another preferred embodiment a template is placed over the arraying chip to physically separate the individual arrays into compartments. Such templates can be made out of a wide variety of materials including plastics and metals. PDMS is a preferred material.

Fabrication

Microdevices and arraying chips can be fabricated using any of a variety of processes. In preferred embodiments they are produced using variations of conventional micromachining and semiconductor fabrication methods. Such methods are described and referenced in U.S. Pat. No. 7,015,047 and US Patent Application 2002/0081714 as well as in reviews and textbooks that discuss photolithographic or MEMS fabrication techniques (for example in Banks, Microengineering, MEMS, and Interfacing: A Practical Guide, CRC Press, 2006). Additional features on the submicron scale can be included in microdevices and arraying chips by means of nanofabrication techniques (for example those described in Stepnova, M. & Dew, S., Nanofabrication: Techniques and Principles, Springer, 2012).

Magnetic Field Generators, Detailed Description

The magnetic fields necessary to drive the magnetic assembly arraying process can be produced by electromagnets, permanent magnets, or a combination of the two.

In a preferred embodiment, the magnetic field generators consist of individual nested sets of electromagnetic coils, similar to Helmholtz coils but wherein the individual coils that would comprise a Helmholtz coil can be independently regulated. In a further preferred embodiment the coils contain magnetic cores containing iron or ferrite or any other magnetic alloys. In another preferred embodiment the magnetic field generating system contains a DC power supply capable of producing outputs of either positive or negative polarity. In a farther preferred embodiment the magnetic field generating system contains an AC power supply suitable for generating a demagnetizing pulse.

### B. System for Parallel FRAP

In the presence of intense light of the appropriate wavelength, a fluorescent molecule will undergo photobleaching resulting in the permanent loss of fluorescence. The extent to which photobleaching occurs is dependent on a variety of experimental parameters. Such procedures are well established and a wide array of photobleaching procedures has been used to measure properties of membrane-based systems. One common feature of such systems is that photobleaching and analysis of post-photobleaching events are carried out in an inherently sequential manner. One type of assay, fluorescence recovery after photobleaching (FRAP), typically uses a microscope objective to direct an intense light source to rapidly photobleach a portion of the sample. The recovery of fluorescence in the photobleached region is then monitored over time. FIG. 4 shows a schematic of this process. Even high-throughput FRAP type experiments and FRAP experiments using membrane microarrays use this sequential method of analysis. Due to the use of confocal or TIRF optics FRAP-based experiments photobleach and observe recovery from the same side of the sample being studied (FIG. 4).

The ability to successfully create SLBs on microdevices and carry out conventional FRAP type experiments is demonstrated in FIG. 5. In that figure SLBs were produced on the microdevice surface by the spontaneous fusion of Small Unilamellar Vesicles (SUVs) prepared from a 99:1 mixture of 1-Palmitoyl-2-oleoyl-sn-glycero-3-phosphocholine and N-(Texas Red sulfonyl)-1,2-dihexadecanoyl-sn-glycero-3-phosphoethanolamine. FRAP experiment was carried out on an inverted epi-fluorescence microscope with a 40× objective and photobleaching by laser radiation at 568.2 nm from a 2.5 W mixed gas Ar+/K+ laser.

Instead of using optical elements to focus the photobleaching light onto a desired portion of the membrane, masking elements can be part of the substrate containing the membrane and photobleaching accomplished by light passing through the substrate FRAP Mask to the desired area of the membrane. FIG. 6 shows a schematic of this process utilizing a “FRAP Mask” within a substrate. The FRAP Mask can be shaped into any desired shape. In addition to the usual circular photobleaching pattern the FRAP Mask can be used to produce photobleaching in the form of a large variety of different patterns, including square, rectangular, other geometric shapes, interspaced lines (e.g., Ronchi pattern), etc., examples of which are shown schematically in FIG. 7. Reports have indicated that certain noncircular photobleaching patterns provide superior results to circular patterns in FRAP-based experiments (Smith & McConnell, 1.978; Kung et al. 2000). Additionally, the use of or more than one photobleaching pattern permits more accurate analysis of the diffusion properties. In the existing art such patterns are generated either by interference optics or by the use of a projection mask. These projection masks differ from the FRAP Mask presented here in an important way: the FRAP Mask is an integral part of the substrate while a projection mask is not. Consequently, in the present invention the patterning of the region of photobleaching is determined by the substrate and not solely by the optical system. Additionally the preferred methods of using a FRAP Mask differ from projection methods in that photobleaching is achieved by directing light through one face of the substrate while monitoring fluorescence recovery on the opposite face of the substrate.

A FRAP Mask can be patterned and produced by a wide variety of methods employed in the MEMS and microfabrication field, including photolithographic patterning, microcontact printing, lift-off, RIE, ion milling, etc. Any layer that reduces the amount of light passing through it can be used as a FRAP Mask. In a preferred embodiment the FRAP Mask is formed by an opaque metal layer. Because high intensity light is used for photobleaching it is desirable that the FRAP Mask does not undergo appreciable heating due to absorbance of photobleaching light. Materials that reflect the majority of the photobleaching light are preferred. Exemplary materials include Ti, Cr, Pt, Au, Ag, Ni, Fe, V, etc. In another preferred embodiment the FRAP Mask is composed of a metal nitride or metal carbide. In another preferred embodiment the FRAP Mask is formed by means of a dichroic mirror, Such dichroic mirrors are generally composed of multiple layers of dielectric material that act as a mirror to reduce the amount of light that can pass through the mask. As discussed above, such dielectric mirrors are widely used to enhance fluorescent signal as they selectively reflect at specific wavelengths. In a preferred embodiment multiple MAP Masks are stacked within a substrate to improve light blocking performance and reduce heating, once such preferred embodiment being shown schematically on FIG. 8D. Schematic examples of FRAP Masks within microdevices are shown in FIG. 8, including examples showing FRAP Masks composed of mirrors and resonators. Precise alignment (submicron) of such multiplayer processes is routinely achieved in the art, as an example, a dielectric mirror and Ti layer can be patterned at the same time using ion milling to produce a precisely aligned stacked pair of FRAP Masks such as shown schematically in FIG. 8D.

In one embodiment the substrate contains a FRAP Mask that produces multiple regions for photobleaching. In another embodiment the substrate contains wells or barriers that prevent SLBs in one photobleaching region from being able to diffuse to another photobleaching region. The FRAP Mask need not be a continuous film and instead may give the appearance of an array of smaller masks.

While a FRAP Mask can be placed on large planar substrates such as a microscope slide a preferred embodiment is to place a FRAP Mask within an individual microdevice. In further preferred embodiments such microdevices are substantially planar. Additionally such microdevices can contain patterned magnetic elements. In a preferred embodiment magnetic elements contain a predetermined preferential axis of magnetization. In a preferred embodiment such microdevices are encoded. Such microdevices containing magnetic material and encoded are described U.S. Pat. Nos. 7,718,419 and 7,811,768, US Patent Applications 20080176762 and 20080176765, and Herold et al. 2008. Such microfabricated microdevices can contain recessed wells to protect the membrane (lipid, cell, etc.) from damage. Microdevices can be composed of a wide variety of materials, in a preferred embodiment the outer surfaces of the microdevices are composed of oxides including SiO₂, TiO₂, or Al₂O₃. Multiple FRAP Masks, including those composed of dielectric mirrors, can be incorporated into the microdevices. In a further preferred embodiment the substrates contain a dielectric mirror that enhances the fluorescence signal of the assay (e.g. the monitoring of the fluorescence recovery following photobleaching). The optimal wavelength of the dielectric mirror used for the FRAP Mask need not be the same as that used for the fluorescence process monitoring surface. In another preferred embodiment the dielectric mirror allows photobleaching light to pass through one face of the substrate, but enhances the fluorescence on the other side of the substrate used for fluorescence monitoring. Such wavelength specific dichroic mirrors are widely used in fluorescence microscopy.

As discussed above and in US Patent Application 20080176762 and U.S. Pat. Nos. 7,718,419 and 7,811,768 microdevices can contain other components and features. The microdevice can contain additional surface patterning to protect membrane from damage or to localize the membrane components to a portion of the microdevice. Examples of such patterning include wells, walls, and posts. The microdevice can contain one or more of such wells, walls, or posts. FIG. 8 shows a variety of examples of microdevices containing FRAP Masks that include other features in combination including wells, magnetic elements, and optical codes.

In addition to the features depicted in FIG. 8, the microdevice can contain partially enclosed “slots”. Such slots consist of a region of the microdevice that contains both an upper and a lower layer. Such slots can be the full length or full width of the microdevice or be only a small portion of the overall microdevice dimensions. A microdevice can contain one or more such slots. Slots can be adjacent or stacked. The height of the slot can range from a nanometer to 10 s of microns or larger, in a preferred embodiment each slot has an opening on opposite edges of the microdevice to facilitate construction and use of the slot by means of capillary forces. Slots can be readily produced using standard microfabrication methods to deposit sacrificial layers within the microdevice. The sacrificial layer(s) is then dissolved to produce the slot. The top and bottom surfaces of the slot can be of different materials to facilitate the use of different attachment chemistries on the two internal surfaces of the slot. Preferred examples include the use of metals, nitrides and metal oxides including silicon dioxide, titanium dioxide, silicon nitride, and gold. In another preferred example a slot is produced by means of multiple sacrificial layers such that the sacrificial layers can be independently removed to expose only a single surface or portion of a surface. Such pairs of sacrificial layers include polymers and metals, examples include a polymer organic solvent and a metal or polymer soluble in aqueous solution or two metals such as copper and aluminum that can be selectively dissolved using appropriate solution conditions. The use of sacrificial layers is well established art. Such slots can also be produced on a lame planar surface to produce an array of slots using the same microfabrication procedures. FIG. 9 shows schematic examples of slots.

In a preferred embodiment microdevices are arrayed on an arraying chip prior to FRAP analysis. The photobleaching source is comprised of a high intensity light source such as lamp or laser and is incident upon the arrayed microdevices from the opposite side as the imaging system. In a preferred embodiment a pulsed laser is used. While FRAP experiments are typically carried out by photobleaching at or near the principal absorbance band of the fluorophore, photobleaching can also be carried out at other wavelengths either at lower wavelengths or higher wavelengths. In a preferred embodiment photobleaching is achieved by multiphoton processes using higher wavelengths than the principle absorbance band of the fluorophore (Eggeling et al, 2005). In another preferred embodiment photobleaching is achieved, by using lower wavelengths than the principle absorbance band of the fluorophore either alone or in combination with excitation in the principle absorbance band of the fluorophore (Eggeling et al. 2005, 2006). Such preferred embodiments allow rapid photobleaching of fluorophores which are resistant to bleaching in their main absorbance; this is an advantage in FRAP assays where photobleaching during measurement in the recovery phase is undesirable.

Microdevices such as those discussed above are compatible with conventional FRAP analysis using a microscope system. FIG. 5 shows the results of a FRAP experiment carried out on a microdevice using the experimental configuration shown schematically in FIG. 4. FIG. 10 shows results of a FRAP experiment carried out on arrayed microdevices, each microdevice containing a FRAP Mask using the experimental configuration shown schematically in FIG. 6.

A schematic example of a system using a FRAP Mask for simultaneous FRAP analysis is shown in FIG. 6 and a schematic of the FRAP process on an individual microdevice containing a FRAP Mask is shown in FIG. 11. The system comprises a substrate, an imaging system, and photobleaching components (optics and light source). As discussed above, a preferred embodiment of the substrate is an arraying chip containing a plurality of lipid bilayer regions wherein each bilayer region is localized on an individual microdevice; each microdevice comprising a substrate, a FRAP Mask, an optical encoding pattern, and a patterned magnetic material wherein the patterned magnetic material has a predetermined preferential axis of magnetization. In order to carry out a FRAP analysis a photobleachable fluorescent monitorable reagent (e.g. fluorophore) must be present in the lipid bilayer. A wide range of suitable fluorescent reagents should be apparent to those skilled in the art. Suitable fluorescent reagents include dyes; examples of suitable dyes include those based upon fluorescein, rhodamine, coumarin, and cyanine as well the AlexaFuor, DyLight, and ATTO families of dyes. Additional examples of suitable fluorescent reagents include proteins such as phycoerythrin and green fluorescent protein and fluorescent nanoparticles. The fluorescent reagent present in the lipid bilayer may be covalently or noncovalently tethered to a component in the bilayer (e.g. a lipid or protein); formation and composition of such bilayers is discussed in the following sections. Photobleaching is achieved by a high intensity light source (e.g. a pulsed laser as described above) directed to one face of substrate (e.g. corresponding to the underside of the arraying chip in the schematic shown in FIG. 6) by means of bleaching optics. The bleaching optics consists of mirrors, lenses, diffusers, etc to illuminate the substrate in a uniform or near uniform manner. Such optical components are widely found in laser optical systems and their use and construction would be apparent to those skilled in the art. Fluorescence recovery after photobleaching (FRAP) is monitored on the opposite face of the substrate [e.g. corresponding to the topside (arraying surface) of the arraying chip in the schematic shown in FIG. 6] by means of an imaging system. Such an imaging system (an excitation source and fluorescence monitoring system) can be composed of a light source, optical filters, lenses and a sensor such as a CCD, CMOS, or PMT device. Examples of such imaging systems are well known in the art and include commercially available microarray scanners, microplate scanners, and fluorescent microscopes. In a preferred embodiment the imaging system utilizes a wide field high numerical aperture low magnification objective. In preferred embodiments the optical components include electronically controlled shutters to optically isolate the imaging system from the bleaching light source. In an exemplary FRAP analysis described by the current invention, the FRAP Mask containing substrate is subjected to a photobleaching event (e.g. a series of laser pulses) after which the fluorescence recovery is monitored (e.g. PMT or CCD output collected on a computer) until fluorescence has fully recovered. In preferred embodiments the duration of the photobleaching event is less than 1 second. In further preferred embodiments the duration of the photobleaching event is less than 1 millisecond. In preferred embodiments lag time between the initiation of the photobleaching event and the initiation of the monitoring of fluorescence is less than 1 second, in further preferred embodiments lag time between the initiation of the photobleaching event and the initiation of the monitoring of fluorescence is less than 1 millisecond.

In a preferred embodiment the number of microdevices subjected to simultaneous photobleaching and subsequent simultaneous monitoring of fluorescence recovery is greater than 100. In other preferred embodiments the number of microdevices subjected to simultaneous photobleaching and subsequent simultaneous monitoring, of fluorescence recovery is greater than 1,000, 10,000, or 100,000.

### C. Methods of Forming a Membrane Library

In another aspect, the present inventive subject matter is directed to a method of forming a collection of different microdevices (a “library”) containing distinct moieties such as lipids, cushion layers, proteins, or dyes. Such libraries of microdevices can be produced by using a split and mix combinatorial approach (Lam et al. 1997). In a split-and-mix synthesis process, particles are randomly divided (split) and placed into reaction chambers for coupling. After each coupling step, particles are pooled and randomly divided among the reaction chambers for the next coupling step. This process is repeated to produce a random library. In the case of encoded microdevices each microdevice can have a unique code to identify it—the general manufacturing process of such libraries are discussed in U.S. Pat. Nos. 7,718,419 and 7,811,768 and US Patent Applications 20080176762 and 20080176765. In the case of lipid libraries which are collections of distinct components rather than covalently coupled polymers some additional considerations arise. Consider the following example for formation of an SLB library involving three steps. In the first step polymers such as those listed above (e.g. PEI, PDDA, PSS, PEG, etc) are grafted to one or more surfaces of the microdevices in varying densities and thicknesses. For purposes of this example each step is carried out in one well of a well plate (e.g., 96-well microtiter plate) where each well contains a different polymer condition and a collection of microdevices of known code in each well (e.g., codes 1-10,000 in well #1, codes 10,001-20,000 in well #2, etc). Following polymer attachment the microdevices can be pooled and split into groups (e.g. 10) for the attachment of tethering molecules. Cholesterol and a reactive lipid (e.g., the lipid 1,2-dipalmitoyl-sn-glycero-3-phosphoethanolamine-N-succinyl (succinyl PE) coupled to free amines on the surface of the polymer through an EDC coupling reaction) can be grafted to the mixtures of polymer cushion at various densities from 0-10% coverage. Individual pools of microdevices from the tethering reactions can then be arrayed and their codes read for identification purposes. Microdevices can be disarrayed magnetically and pooled and split into groups. The individual groups can then be arrayed and their codes read for identification purposes, dismayed magnetically, and placed into wells containing lipid compositions to be tested (e.g., 10). Lipids can be attached by a variety of methods, for example, by the addition of microdevices to various solutions containing vesicles of distinct composition. The individual batches of microdevices can then be rinsed, several times to remove unfused vesicles, and, mixed together to create the final library. Using 96 polymer combinations, 10 tethering combinations, and 10 lipid combinations leads to a library size of 9600 (96×10×10). Using 10,000 microdevices per well in the first stage would lead to an average representation for each combination in the library of ˜100. Only 20 arraying/reading steps are required to generate such a library. Membrane proteins can be added by including them at the stage of vesicle or they can be added in a separate subsequent step in a detergent solubilized form. The addition of proteins as a separate step would increase the library size. Such methods of forming protein containing SLBs are well established in the art.

The above example represents one type of lipid-based library consisting of SLBs. Such libraries can be screened using a variety of methods, including spectroscopy (e.g. polarized light), fluorescence based methods (e.g., FRAP), and chemical reactivity (e.g., protein activity). The results of such screens can be used to determine optimal conditions for any desired parameter, e.g., protein activity, protein stability, lipid fluidity, etc. Additionally, such libraries can be used for drug screening, e.g., a library containing a plurality of drug targets such as ion channels or GPCRs.

Any of the microdevice designs presented above can be used to create the SLB libraries. In a preferred embodiment, microdevices contain recessed wells where the lipid is attached or localized. In a further preferred embodiment, the surface of the wells is patterned to provide differential regions of surface attachment. Such patterned regions can be used to attach chemical sensors, e.g., ion sensitive fluorescent dyes. Such chemical sensors form an underlying layer that can used to evaluate membrane integrity by immersing the completed microdevice (with SLB) in solution containing the compound that interacts with the chemical sensor to trigger its response. In the case of fluorescence-based, sensors, a preferred embodiment is for the substrate underlying the sensor to contain a fluorescence enhancement feature, e.g., mirror or resonator. Additionally, such surface bound chemical sensors can be used to detect the opening or closing of ion channels. Such ion channel opening/closing events can be part of a study of ion channel activity or it can be part of a coupled assay where binding of a molecular to a membrane-bound component, e.g. a G protein coupled receptor (GPCR), triggers activation of the channel. FIGS. 11-14 show schematic representations of such exemplary processes.

Another type of library is composed of lipid cubic phases (mesophase or sponge phase). Such libraries can be used to evaluate conditions for protein crystallography. The same general principles as for the SLB library can be used, e.g., sequential steps involving polymers, tethers, lipids, and proteins can be used. However, mesophase and sponge phases are three dimensional lipid arrangements that are not firmly attached to the underlying surface. Consequently such phases are typically created in wells and capillaries. For creating libraries of mesophase and sponge phase lipid forms in microdevices slots are a preferred embodiment. Such slots can be filled using capillary force to create or localize a mesophase or sponge phase within the slot. Top and bottom surfaces can be coated with different lipid or cushions on either or both internal faces of slot—top and bottom chemistries including lipids and cushions can be different on each surface since as discussed above the attachment surfaces or exposure of the two internal faces can be different. Capillary, electrophoretic, and vacuum forces can be used to fill and empty the slots of unbound materials. Microdevices containing cubic lipid phases can be displayed on an arraying chip. Salts and other solutions can be allowed to diffuse in to the slots to facilitate crystallization. Crystallization and optimization of crystallization can be monitored by a variety of methods including polarized light microscopy and FRAP.

An additional type of library comprises cells, cellular organelles, or vesicles. These lipid moieties can be attached to the microdevice surface by general or specific interactions that target lipid, protein, carbohydrate, DNA, RNA, or other molecules on the surface of the lipid containing moiety. In a preferred example, antibodies on the surface of the microdevice are used to capture a specific lipid containing moiety. In another preferred embodiment a microdevice contains multiple types of lipid moieties. For example, it may be desirable to assay a particular reaction in one lipid containing moiety by measuring the response in a second moiety, such as release of a secreted factor by one cell in response to drug or other stimuli. In such an example a microdevice would contain two cell types: one that responds to the drug and one that responds to the other cells response.

Libraries can be used in combination e.g. SLB and vesicle, cell and vesicle, etc.

### D. Method of Using a Membrane Library

Microdevice membrane libraries can be utilized in two general formats: i) They can be used as a collection of particles suspended in solution (a liquid array format) to interact with a sample containing target moieties (e.g. moieties that interact with one or more components of the membrane). Following such interaction the microdevices can be arrayed and analyzed. ii) They can be used in a fixed array format in which the microdevice library is arrayed prior to introduction of interacting moieties of interest. In both approaches final analysis occurs on the arrayed microdevices; such analyses can involve a variety of methodologies including FRAP, fluorescence, and electrical-based detection. Membrane libraries can also be used in a manner that combines both methodologies, e.g., interaction with moieties of interest in liquid array format followed by arraying and further interaction with additional moieties of interest after arraying. In addition to the advantage of smaller sample volumes and more rapid kinetics, the liquid array format results in faster interaction rates between microdevice-bound moieties and moieties in solution. This improvement in reaction rate is particularly useful when the moieties in solution are slow diffusing, e.g. large proteins, cells, DNA, etc. The fixed array format facilitates continuous real-time monitoring of a process, for example, following the fluorescence change on a microdevice from the addition of a component (such as a drug) until an equilibrium state is reached. FRAP represents a type of continuous real-time experiment. By contrast, a liquid array experiment often involves a step such as arraying or washing that prevents continuous real time monitoring. Fixed array approaches are well suited for assays involving addition of rapidly diffusing molecules such as small-molecule drugs or salts. Such reagents can be delivered by a variety of methods including pipetting or by means of microchannels in the arraying chip.

One very general application for an SLB library is to optimize SLB composition for a particular membrane-based assay. Such optimization can relate to a wide range of properties including membrane fluidity, SLB stability, and stability of specific components in the membrane (e.g. a protein of interest). These properties can be monitored by various techniques including FRAP and protein-function assays e.g. target binding, enzymatic activity, fluorescence, etc).

Another use of microdevice membrane libraries is to determine and optimize the membrane and membrane components for an assay. For example, consider a FRAP-detected assay that measures receptor-ligand interactions by determining the change in membrane fluidity or protein diffusion rates that occurs due to ligand binding. Different membrane compositions including membrane proteins and the concentrations of those proteins will affect the results. A microdevice library can be used to determine those compositions that correspond to optimal assay conditions. The optimal assay conditions need not be the most sensitive with regard to either ligand concentration or affinity and library screening can result in the identification of a set of compositions that when used in parallel (e.g. a subset of the fill library, which is in itself still a library) allow assay dynamic range to be significantly enhanced.

While some membrane-based assays are generally carried out in a single- or low-plex manner (e.g. a drug library screened against a single receptor) others can be carried out in a high multiplex manner. For example, consider a GPCR-based assay. GPCRs exist in hetero- and homo-dimer form. There are ˜800 known human GPCR genes. A library of GPCR homo- and hetero-dimers on microdevices can be used to measure the effect of drugs and protein factors on different GPCR family members. Such measurements could aid in correlating drug function to particular GPCR combinations, useful for understanding GPCR function and identification of drug interacting proteins. Of particular importance such libraries could be very useful in screening drugs for possible undesirable side effects by determining and characterizing the subset of GPCR dimers that the drugs interact with. For example, a drug designed to target a specific GPCR can actually target a particular subset of homo- and hetero-dimers of containing that GPCR. By determining this subset rather than using a single homo-dimeric GPCR in drug screening drugs with fewer undesired effects can be determined.

Another application of membrane based microdevice libraries are cell arrays. Cells in the library can be of different cell types, e.g. hepatocytes and fibroblasts or they can be different forms of the same cell type, e.g. HEK 293 cells containing different transiently transfected genes. Such libraries allow a single drug or molecule to be screened simultaneously against a range of cells. Analysis can be achieved by a variety of methods used in cell-based assays including FRAP, cell morphology changes, fluorescence, cell death, etc.

A further use of membrane based microdevice libraries is in electrophoretic separations for the analysis and purification of membrane bound proteins. Libraries can be used to rapidly determine optimal SLB composition for a particular electrophoresis assay or purification. In a typical microdevice electrophoresis optimization procedure, an arrayed set of microdevices corresponding to a library of different membrane compositions, containing the protein or proteins of interest, is subjected to an electric field under appropriate buffer conditions (electrophoretic conditions). Proteins are labeled with fluorophore (either covalently or noncovalently) and subjected to electrophoretic force to stack the protein against one edge of the microdevice. Such “stacking”, results in a substantial portion of the protein(s) of interest concentrating into a band that can be monitored by fluorescence. The direction of the electric field is reversed and the stacked proteins move in the opposite direction, movement being monitored by fluorescence. The relative mobility of each target protein versus another target or standard can be measured for each microdevice. Because of the nature of the assays the microdevices used for electrophoretic optimization are preferentially longer in the direction of electrophoretic mobility as shown schematically in FIG. 15. Additionally, stacking requires that proteins not be able to run out of the membrane during “stacking” so slots or recessed wells are necessary, preferably with a polymer cushion layer to minimize protein denaturation. In a preferred embodiment both electrophoretic and electroosmotic focusing are used to separate proteins. Electrophoretic-electroosmotic focusing (EEF) allows proteins to be focused into narrow bands on supported lipid bilayers. EEF separations of membrane proteins have been reported in channels of 380 micron length (Liu et al. 2011).

Another use for a microdevice lipid library is to determine suitable crystallization conditions for membrane proteins. As discussed above, libraries of lipid cubic phases can be arrayed. Salts and other solutions can be allowed to diffuse in to the slots to facilitate crystallization with crystallization monitored by a variety of methods including polarized light microscopy and FRAP. A single arraying chip can hold many tens of thousands of microdevices allowing a very large number of different conditions to be evaluated on a single arraying chip. Moreover because the microdevices use very little protein and can be monitored in a highly parallel manner (including by FRAP) many such arraying chips could be prepared each arraying chip evaluating a different salt condition. Consequently, if desired many millions of different crystallization conditions can be monitored greatly increasing the likelihood of identifying the desired crystallization conditions.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used herein, and unless the context dictates otherwise, the term “coupled to” is intended to include both direct coupling (in which two elements that are coupled to each other contact each other and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

### REFERENCES

Albertorio F., Diaz A. J., Yang T. L., Chapa V. A., Kataoka S., Castellano E. T., et al. (2005) Fluid and air-stable lipopolymer membranes for biosensor applications. Langmuir 21, 7476-7482.
Asian. K., Gryczynski, I., Malicka, J., Matveeva, E, Lakowicz, J. R., Geddes, C. D. (2005). Metal-enhanced fluorescence: An emerging tool in biotechnology. Curr. Op. Biotechnol. 16, 55-62.
Axelrod, D. et al. (1976) Lateral motion of fluorescently labeled acetylcholine receptors in membranes of developing muscle fibers. Proc. Natl. Acad. Sci. USA 73, 4594-4598.
Barritault, P., Getin, S., Chaton, P. Andre, B., Vinet, F. Fouque, B. (2004). Optical thin films serving biotechnology: fluorescence enhancement of DNA-chip. Advances in Optical Thin Films Proceedings of the SPIE 5250, 12-20.
Baumeister, P. W. (2004). Optical Coating Technology. SPIE Press (Bellingham, Wash.),
Caffrey M. (2011) Crystallizing membrane proteins for structure-function studies using lipidic mesophases, Biochem. Soc. Trans. 39, 725-732.
Castellana E. T., Cremer P. S. (2006) Solid supported lipid bilayers: From biophysical studies to sensor design. Surf Sci Rep 61, 429-444.
Castellano E. T., Cremer P. S. (2007) Imaging large arrays of supported lipid bilayers with a macroscope. Biointerphases 2, 57-63.
Claesson M., Frost R., Svedhem S., Andersson M. (2011) Pore Spanning Lipid Bilayers on Mesoporous Silica Having Varying Pore Size. Langmuir 27, 8974-4982
Cremer P. S., Yang T. L. (1999) Creating spatially addressed arrays of planar supported fluid phospholipid membranes. Journal of the American Chemical Society 121, 8130-8131.
Deng Y., Wang Y., Holtz B., Li J. Y., Traaseth N., Veglia G., et al. (2008) Fluidic and air-stable supported lipid bilayer and cell-mimicking microarrays. Journal of the American Chemical Society 130, 6267-6271.
Duveneck, G. L., Abel, A. P., Bopp, M. A., Kresbach, G. M., Ehrat, M. (2002). Planar waveguides for ultra-high sensitivity of the analysis of nucleic acids Analytica Chim. Acta 469, 49-61.
Edidin, M., Zagyansky, Y. & Lardner, T. J. (1976) Measurement of membrane protein lateral diffusion in single cells. Science 191, 466-468.
Eggeling, C., Andreas Volkmer, A., Seidel, C. A. M. (2005) Molecular Photobleaching Kinetics of Rhodamine 6G by One- and Two-Photon Induced Confocal Fluorescence Microscopy. Chem Phys Chem 6, 791-804.
Eggeling, C., Widengren, J., Brand, L., Schaffer, J., Felekyan, S, Seidel, C. A. M. (2006) Analysis of photobleaching in single-molecule multicolor excitation and Förster resonance energy transfer measurements. J. Phys. Chem. A 110, 2979-2995,
Fort, E., Grésillon, S. (2008). Surface enhanced fluorescence. J. Phys. D. Appl. Phys. 41, 013001.
Groves J. T. (2002) Membrane array technology for drug discovery. Curr Opin Drug Discov Dev 5, 606-612.
Herold., C. D., Nguyen, B. T., Rothwarf, D. M. (2008) A Novel, Scalable Liquid Array Platform, Journal of the Association for Laboratory Automation. 13, 344-350.
Kam, L., and Boxer, S. G. (2000) Formation of Supported Lipid Bilayer Composition Arrays by Controlled Mixing and Surface Capture. JACS 122, 12901-12902.
Kaufmann S., Sobek J., Textor M., Reimhult, E, (2011) Supported lipid bilayer microarrays created by non-contact printing. Lab Chip 11, 2403-2410.
Kiessling, V., Domanska, M. K., Murray, D., Wan, C., and Tamm L. K. (2008) Supported Lipid Bilayers: Development and Application in Chemical Biology. Wiley Encyclopedia of Chemical Biology, John Wiley & Sons, Hoboken, Volume 4, pp. 411-422.
Kung L. A., Groves J. T., Ulman N., Boxer S. G. (2000) Printing via photolithography on micropartitioned fluid lipid membranes. Advanced Materials 12, 731-734.
Lakowicz, J. R., Ray, K., Chowdhury, M., Szmacinski, H., Fu, Y., Zhang, J., Nowaczyk, K. (2008), Plasmon-controlled fluorescence: a new paradigm in fluorescence spectroscopy, Analyst 133, 1308-1346,
Lee B, K., Lee H. Y., Kim P., Suh K. Y., Kawai T. (2009) Nanoarrays of tethered lipid bilayer rafts on poly(vinyl alcohol) hydrogels. Lab Chip 9, 132-139.
Li L., Ismagilov R. F. (2010) Protein crystallization using microfluidic technologies based on valves, droplets, and Slip Chip. Annu. Rev. Biophys. 39, 139-158,
Liu C., Monson C. F., Yang T., Pace H., Cremer P. S. (2011) Protein separation by electrophoretic-electroosmotic, focusing on supported lipid bilayers. Anal. Chem. 83, 7876-7880.
Ma C., Srinivasan M. P., Waring A. J., Lehrer R. I., Longo M. L., Stroeve P. (2003) Supported lipid bilayers lifted from the substrate by layer-by-layer polyion cushions on self-assembled monolayers. Colloid Surf B-Biointerfaces 28, 319-329,
Majd S., Mayer M. (2008) Generating Arrays with High Content and Minimal Consumption of Functional Membrane Proteins. Journal of the American Chemical Society 130, 16060-16064.
Monson C. F, Pace H. P., Liu C., Cremer P. S. (2011) Supported bilayer electrophoresis under controlled buffer conditions. Anal. Chem. 83, 2090-2096.
Mukundan, H., Anderson, A. S., Grace, W. K., Grace, K. M., Hartman, N., Martinez, J. S., Swanson, B. I. (2009). Waveguide-Based Biosensors for Pathogen Detection. Sensors 9, 5783-5809.
Naumann C. A., Prucker O., Lehmann T., Ruhe J., Knoll W., Frank C. W. (2002) The polymer-supported phospholipid bilayer: Tethering as a new approach to substrate-membrane stabilization. Biomacromolecules 3, 27-35.
Nath A, Atkins W. M. Sligar S. G. (2007) Applications of phospholipid bilayer nanodiscs in the study of membranes and membrane proteins. Biochemistry 46, 2059-2069.
Nethschäfer, D., Budach, W., Wanke, C., Chibout, S. D. (2003). Evanescent resonator chips: a universal platform with superior sensitivity for fluorescence-based microarrays. Biosens. Bioelectron. 18, 489-497.
Neuschäfer, D., Marrer, E, Budach, W. (2005). Novachip evanescent resonator technology. Innov. Pharm. Technol. 2005, 78-82.
Nordland G., Lönneborg R., Brzezinski P. (2009) Formation of supported lipid bilayers on silica particles studied using flow cytometry. Langmuir 25, 4601-4606.
Onda M., Lvov Y., Ariga K., Kunitake T. (1997) Molecularly flat films of linear polyions and proteins obtained by the alternate adsorption method, Jpn J Appl Phys Part 2—Lett 36, L1608-L1611.
Pawlak, M., Schick, F., Bopp, M. A., Schneider, M. J., Oroszlan, P., Ehrat, M. (2002). Zeptosens' protein microarrays: a novel high performance microarray platform for low abundance protein analysis. Proteomics 2, 383-393.
Phillips K. S., Kottegoda S., Kang K. M., Sims C. E., Allbritton N, L. (2008) Separations in poly(dimethylsilaxane) microchips coated with supported bilayer membranes. Anal. Chem. 80, 9756-9762,
Ray. K., Chowdhury, M. H., Zhang, J., Fu, Y., Szmacinski, H., Nowaczyk, Lakowicz, J. R. (2009). Plasmon-Controlled Fluorescence Towards High-Sensitivity Optical Sensing. Adv. Biochem. Engin./Biotechnol. 116, 29-72,
Rayan, G.; Guet, J.-E.; Taulier, N.; Pincet, F.; Urbach, W. (2010) Recent Applications of Fluorescence Recovery after Photobleaching (FRAP) to Membrane Bio-Macromolecules. Sensors 10, 5927-5948.
Sackmann E. (1996) Supported membranes: Scientific and practical applications. Science 271, 43-48,
Schmitt, K., Oehse, K., Sulz, G., Hoffmann, C. (2008), Evanescent field sensors based on tantalum pentoxide waveguides—a review. Sensors 8, 711-738.
Smith K. A., Gale B. K., Conboy J. C. (2008) Micropatterned fluid lipid bilayer arrays created using a continuous flow microspotter. Anal Chem. 80, 7980-7987.
Smith, B. A., McConnell, H. M. (1978) Determination of molecular motion in membranes using periodic pattern photobleaching. Proc. Natl Acad. Sci. USA 75, 2759-2763.
Southwell, W. H. (1999). Omnidirectional mirror design with quarter-wave dielectric stacks. Appl. Opt. 38, 5464-5467.
Tanaka M., Sackmann E. (2005) Polymer-supported membranes as models of the cell surface. Nature 437, 656-663.
Troutier A.-L, Ladavière C. (2.007) An overview of lipid membrane supported by colloidal particles. Adv Colloid interface Sci. 133, 1-21.
Wagner M. L., Tamm L. K. (2000) Tethered polymer-supported planar lipid bilayers for reconstitution of integral membrane proteins: Silane-polyethyleneglycol-lipid as a cushion and covalent linker. Biophys J 79, 1400-1414.
Wilson et al. (1988) J. Immunol. Methods 107, 231-237.
Wong J. Y., Park C. K., Seitz M., Israelachvili J. (1999) Polymer-cushioned bilayers. II. An investigation of interaction threes and fusion using the surface forces apparatus. Biophys J 77, 1458-1468.
Xu F., Liu W., Hanson M. A., Stevens R. C., Cherezov V. (2011) Development of an Automated High Throughput LCP-FRAP Assay to Guide Membrane Protein Crystallization in Lipid Mesophases. Cryst. Growth Des. 11, 1193-1201.
Yamazaki V., Sirenko O., Schafer R. J., Nguyen L., Gutsmann T., Brade L., groves, J. T. (2005) Cell membrane array fabrication and assay technology, BMC Biotechnology 5, 18.
Zhang L. Q., Longo M. L., Stroeve P. (2000) Mobile phospholipid bilayers on a polyion/alkylthiol layer pair. Langmuir 16, 5093-5099.

What is claimed is:

1. A composition comprising:
an arraying substrate containing a plurality of magnetizable magnet elements that have a predetermined preferential axis of magnetization;
a plurality of microdevices comprising a substrate, a FRAP Mask, an optical encoding pattern, and a patterned magnetic material wherein the patterned magnetic material has a predetermined preferential axis of magnetization;
a plurality of lipid bilayer regions wherein each bilayer region is localized on an individual microdevice;
a fluorescent reagent present in the bilayer region; and
wherein the microdevices are located at specific predetermined locations on the arraying substrate.

2. The composition of claim 1 wherein the arraying substrate contains a masking layer complementary to the FRAP mask within the microdevice.

3. The composition of claim 1 wherein a surface area of the plurality of the microdevices is less than 5000 micron².

4. The composition of claim 1 wherein the lipid bilayer is localized to a recessed well in the microdevice.

5. The composition of claim 1 wherein a plurality of the lipid regions are sponge phase or mesophase forms.

6. The composition of claim 1 wherein the lipid bilayer is localized to a slot in the microdevice.

7. A method of simultaneously photobleaching fluorescent reagents located in a plurality of lipid bilayers and subsequently simultaneously monitoring the recovery of fluorescence by photobleaching through one face of an arraying substrate while monitoring fluorescence recovery on an opposite face of said substrate, said method comprising:
providing an arraying substrate containing a plurality of magnetizable magnet elements that have a predetermined preferential axis of magnetization;
providing a plurality of microdevices, each microdevice comprising a substrate, a FRAP Mask, an optical encoding pattern, and a patterned magnetic material wherein the patterned magnetic material has a predetermined preferential axis of magnetization, and wherein the microdevices are located at specific predetermined locations on the arraying substrate;
providing a plurality of lipid bilayer regions wherein each bilayer region is localized on an individual microdevice;
providing a fluorescent reagent present in the bilayer region;
providing a high intensity light source and optics directed towards one face of the arraying substrate
providing an excitation source and fluorescence monitoring system on the face of the arraying substrate opposite to the high intensity light source; and
photobleaching said fluorescent reagent and monitoring the fluorescence recovery on said fluorescence monitoring system.

8. The method of claim 7, wherein the plurality of lipid bilayer regions comprises at least 100 lipid bilayer regions.

9. A system for simultaneously photobleaching fluorescent reagents located on a plurality of microdevices in an array in which fluorescent reagents are photobleached by directing light through one face of the arraying substrate and fluorescence recovery is subsequently simultaneously monitored on the opposite face of said substrate, said system comprising:
an arraying substrate containing a plurality of magnetizable magnet elements that have a predetermined preferential axis of magnetization;
microdevices comprising a substrate, a FRAP Mask, an optical encoding pattern, and a patterned magnetic material wherein the patterned magnetic material has a predetermined preferential axis of magnetization; and wherein the microdevices are located at specific predetermined locations on the arraying substrate;
a plurality of lipid bilayer regions wherein each bilayer region is localized on an individual microdevice;
a fluorescent reagent present in the bilayer region;
a high intensity light source and optics directed towards one face of the arraying substrate; and
an excitation source and fluorescence monitoring system on the face of the arraying substrate opposite to the high intensity light source.
